(19) United States
(12) Patent Application Publication
(10) Pub. No.: US 2022/0401841 A1
(43) Pub. Date: Dec. 22, 2022

(54) USE OF PROJECTILE DATA TO CREATE A VIRTUAL REALITY SIMULATION OF A LIVE-ACTION SEQUENCE

(71) Applicant: Centurion VR, Inc., London (GB)

(72) Inventors: Muhammad Yasser Ghanchi, London (GB); Saad Khalid Khan, Mississauga (CA)

(21) Appl. No.: 17/898,858

(22) Filed: Aug. 30, 2022

Related U.S. Application Data
(63) Continuation of application No. PCT/US21/21021, filed on Mar. 5, 2021.
(60) Provisional application No. 62/986,165, filed on Mar. 6, 2020.

(51) Int. Cl. A63F 13/573; A63F 13/812

(52) U.S. Cl. CPC A63F 13/573; A63F 13/812; A63F 2300/8082

(57) ABSTRACT

Projectile data associated with a projectile launched by a player in a live-action sequence may be used to render an accurate graphical representation of the projectile (and its trajectory) within a virtual reality environment, e.g., for use in a virtual reality game or similar. For example, certain implementations described herein include the use of projectile data characterizing the path of a cricket ball bowled by a player (e.g., the “bowler”) in a live-action cricket match for recreating the same (or substantially the same) path in a virtual reality cricket game. To this end, the present disclosure includes techniques for transforming projectile data for use in a virtual reality environment, creating realistic projectile movement in a virtual reality setting, and determining and recreating post-bounce behavior of a projectile for virtual representation of a bounced projectile.

### CROSS-REFERENCE TO RELATED APPLICATIONS

This application is a bypass continuation that claims priority to International Patent Application No. PCT/US21/21021 filed on Mar. 5, 2021, which claims priority to U.S. Provisional Patent Application No. 62/986,165 filed on Mar. 6, 2020, the entire content of which is incorporated herein by reference.

This application is also related to U.S. patent application Ser. No. 16/15,895 filed on Jun. 22, 2018 (now U.S. Pat. No. 10,265,627), which claims priority to each of the following U.S. provisional patent applications: U.S. Provisional Patent Application No. 62/678,227, filed on May 30, 2018; U.S. Provisional Patent Application No. 62/678,058, filed on May 30, 2018; U.S. Provisional Patent Application No. 62/523,659, filed on Jun. 22, 2017; U.S. Provisional Patent Application No. 62/523,664, filed on Jun. 22, 2017; U.S. Provisional Patent Application No. 62/523,674, filed on Jun. 22, 2017; and U.S. Provisional Patent Application No. 62/523,694, filed on Jun. 22, 2017. Each of the foregoing applications is incorporated herein by reference in its entirety.

### TECHNICAL FIELD

The present disclosure generally relates to virtual reality simulation, and more specifically, in some implementations, to devices, systems, and methods for using projectile data from a live-action sequence in a virtual reality sports simulation.

### BACKGROUND

Virtual reality simulation systems provide users with the perception of being physically present in a virtual reality environment. Users may interact with the virtual reality environment using hardware that provides feedback to the users. Through such feedback, virtual reality simulation systems may be used to simulate experiences such as sports. However, virtual reality simulations of sports have a limited capacity to provide a user with the realistic experience of live-action play of the sport being simulated. Thus, there remains a need for improved virtual reality simulation systems and techniques to provide a user with a more authentic experience.

### SUMMARY

Projectile data associated with a projectile launched by a player in a live-action sequence may be used to render an accurate graphical representation of the projectile (and its trajectory) within a virtual reality environment, e.g., for use in a virtual reality game or similar. For example, certain implementations described herein include the use of projectile data characterizing the path of a cricket ball bowled by a player (e.g., the “bowler”) in a live-action cricket match for recreating the same (or substantially the same) path in a virtual reality cricket game. To this end, the present disclosure includes techniques for transforming projectile data for use in a virtual reality environment, creating realistic projectile movement in a virtual reality setting, and determining and recreating post-bounce behavior of a projectile for virtual representation of a bounced projectile.

In one aspect, a method for virtual reality simulation of a projectile disclosed herein may include: obtaining projectile data characterizing a trajectory of a projectile launched by a player in a live-action sequence, the projectile data including (i) a first position of the projectile corresponding to a location where the projectile is launched by the player, (ii) an initial velocity of the projectile when the projectile is launched by the player, (iii) a bounce position where the projectile contacts a playing surface or is projected to contact the playing surface after being launched by the player, and (iv) a known downstream position of the projectile at a predetermined location downstream from the bounce position; calculating a launch angle for the projectile at, or immediately downstream of, the first position based on the projectile data; calculating a post-bounce velocity and determining a post-bounce directional vector at a location immediately downstream from the bounce position using (i) a predetermined coefficient of restitution between the playing surface and the projectile, and (ii) the known downstream position; determining a post-bounce trajectory disposed between the bounce position and the known downstream position using the post-bounce velocity, the post-bounce directional vector, and the known downstream position; and rendering a graphical representation of the trajectory, including the post-bounce trajectory, with a virtual projectile in a display of a virtual reality environment.

Implementations may include one or more of the following features. The virtual reality environment may be configured for use in a virtual reality cricket simulation, where the projectile is a cricket ball and the player in the live-action sequence is a bowler in a cricket match. The post-bounce velocity may be calculated using a predetermined decrease in velocity from a pre-bounce velocity, the pre-bounce velocity derived from the initial velocity. The predetermined decrease in velocity may be between about 10% and about 15%. The predetermined decrease in velocity may be based at least in part on an attribute of the playing surface that is identified in the projectile data. The attribute of the playing surface may include at least one of a composition of the playing surface, a geographic location of the playing surface, a wetness of the playing surface, and an environmental condition. The predetermined decrease in velocity may be based at least in part on an attribute of the player that launched the projectile that is identified in the projectile data. The predetermined decrease in velocity may be based at least in part on the pre-bounce velocity. When the pre-bounce velocity is above a predetermined threshold, a first decrease in velocity may be used for the post-bounce velocity, and when the pre-bounce velocity is below the predetermined threshold, a second decrease in velocity may be used for the post-bounce velocity, the second decrease in velocity being greater than the first decrease in velocity. The predetermined coefficient of restitution may characterize a manner in which the projectile responds to contact with the playing surface. Rendering the graphical representation of the trajectory, including the post-bounce trajectory, with the virtual projectile may include a displacement of the virtual projectile along the playing surface from the bounce position. The displacement from the bounce position may be dependent upon one or more factors including at least one of: a velocity of the projectile along the trajectory, an attribute of the playing surface, an environmental condition, and an attribute of the player that launched the projectile. The displacement from the bounce position may be fixed.

In one aspect, a method for virtual reality simulation of a projectile disclosed herein may include: obtaining projectile data characterizing a trajectory of a projectile launched by a player in a live-action sequence, the projectile data including (i) a first position of the projectile corresponding to a location where the projectile is launched by the player, (ii) an initial velocity of the projectile when the projectile is launched by the player, and (iii) a second position of the projectile along the trajectory at a second position time, the second position disposed downstream from the first position along the trajectory; calculating a launch angle for the projectile at, or immediately downstream of, the first position based on the projectile data; calculating a number of locations of the projectile along the trajectory based on the projectile data, the launch angle, a mass of the projectile, and application of a predetermined drag coefficient to the projectile, where the number of locations form a first virtual trajectory; and rendering a graphical representation of the first virtual trajectory with a virtual projectile in a display of a virtual reality environment.

Implementations may include one or more of the following features. The virtual reality environment may be configured for use in a virtual reality cricket simulation, where the projectile is a cricket ball and the player in the live-action sequence is a bowler in a cricket match. The second position may be a bounce position of the projectile first contacting a playing surface after being launched by the player. The first virtual trajectory may be disposed between the first position and the bounce position. The method may further include calculating a directional vector of the projectile at the number of locations. The method may further include calculating directional components of the initial velocity of the projectile. The predetermined drag coefficient may correspond to quadratic drag applied to the projectile. The predetermined drag may be applied at every frame of the graphical representation of the first virtual trajectory. The method may further include verifying the first virtual trajectory based on the second position and the second position time. The method may further include adjusting the predetermined drag coefficient according to a deviation between the first virtual trajectory and the second position at the second position time thereby creating a second virtual trajectory. The method may further include comparing a reaction time within the graphical representation to an actual reaction time in the live-action sequence, and adjusting the first virtual trajectory based on a difference therebetween.

In one aspect, a method of virtual reality simulation disclosed herein may include: rendering a game including a ball within a virtual reality environment, the virtual reality environment including a physics engine that controls movement of the ball; rendering a bat within the virtual reality environment, a location of the bat within the virtual reality environment controlled by a game controller, and the physics engine controlling collisions between the ball and the bat; removing control of the ball from the physics engine and applying a custom physics model to movement of the ball as the ball approaches a region of the bat; and, when the ball approaches within a predetermined distance of the region of the bat, returning control of the ball to the physics engine and managing contact between the ball and the bat using the physics engine.

Implementations may include one or more of the following features. The method may further include pre-calculating a path of the ball after contact with the bat. The method may further include pre-calculating a response of one or more artificial intelligence defensive players to the path of the ball after contact with the bat. The method may further include rendering the one or more artificial intelligence defensive players at a frame rate of the virtual reality environment. The ball may be one or more of a baseball, a cricket ball, a softball, a squash ball, and a tennis ball. The bat may be one or more of a baseball bat, a cricket bat, a softball bat, a squash racquet, and a tennis racquet. The custom physics model may include a quadratic drag equation for movement of the ball within the virtual reality environment. The physics engine may use one or more platform-optimized physics calculations. One or more of the platform-optimized physics calculations may include at least one of a hardware acceleration, a graphics processing unit optimization, a physics processing unit optimization, a multicore computer processing optimization, a video card optimization, and a multithreading.

In one aspect, a method for virtual reality simulation of a projectile disclosed herein may include: receiving projectile data in an unstructured format, the projectile data characterizing a trajectory of a number of projectiles launched by a player in a live-action sequence; tagging the projectile data with a date and a time for each of the number of projectiles, thereby providing tagged projectile data; storing the tagged projectile data in a data structure configured to facilitate programmatic retrieval of the projectile data on a per-projectile basis; based on an instruction received from an application programming interface, retrieving projectile data for a selected projectile of the number of projectiles based on a requested date and a requested time; extracting trajectory information from the projectile data for the selected projectile, the trajectory information including (i) a first position of the selected projectile corresponding to a location where the selected projectile is launched by the player, (ii) an initial velocity of the selected projectile when the selected projectile is launched by the player, (iii) a downstream position of the selected projectile at a predetermined position disposed away from the player, and, (iv) when the selected projectile contacts a playing surface in the live-action sequence, a bounce position where such contact occurs; and rendering a graphical representation of the trajectory with a virtual projectile in a display of a virtual reality environment using the trajectory information.

Implementations may include one or more of the following features. The virtual reality environment may be configured for use in a virtual reality cricket simulation, where the projectile is a cricket ball and the player in the live-action sequence is a bowler in a cricket match. The virtual reality environment may be configured for use in a virtual reality baseball simulation, where the projectile is a baseball and the player in the live-action sequence is a pitcher in a baseball game. The method may also include use of projectile data to create a virtual reality simulation of a live-action sequence.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 is a schematic representation of a system for virtual reality simulation.

FIG. 2A is a schematic representation of a user of the system of FIG. 1 during a virtual reality simulation, with the user shown in the physical world.

FIG. 2B is a schematic representation of a virtual reality environment for the virtual reality simulation of FIG. 2A.

FIG. 3A is a perspective view of a bat of the system of FIG. 1.

FIG. 3B is a perspective view of a cutaway of the bat of FIG. 3A.

FIG. 3C is a top view of the cross-section of the bat of FIG. 3A taken along the line 3C-3C in FIG. 3A.

FIG. 4A is a perspective view of a glove of the system of FIG. 1.

FIG. 4B is an exploded view of the glove of FIG. 4A.

FIG. 5A is a perspective view a helmet of the system of FIG. 1, with a display of the helmet shown in a first position.

FIG. 5B is a perspective view of the helmet of FIG. 5A, with the display of the helmet shown in a second position.

FIG. 5C is an exploded view of the helmet of FIGS. 5A and 5B.

FIG. 6 is a schematic representation of pads of the system of FIG. 1.

FIG. 7 is a flow chart of an exemplary method of operating a virtual reality game.

FIG. 8 is a flow chart of an exemplary method of virtual reality simulation.

FIG. 9 is a top view of a cross-section of a bat.

FIG. 10 is a flow chart of an exemplary method for using projectile data.

FIG. 11 is a flow chart of an exemplary method for using projectile data.

FIG. 12 is a flow chart of an exemplary method for using projectile data.

FIG. 13 is a flow chart of an exemplary method for using projectile data.

FIG. 14 is a flow chart of an exemplary method of virtual reality simulation.

### DETAILED DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, for example, the term “or” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “upper,” “lower,” and the like, are words of convenience and are not to be construed as limiting terms.

Described herein are devices, systems, and methods for virtual reality simulations in which a user may use one or more accessories tracked in a physical space to interact with a virtual reality environment. As used herein, a “virtual reality environment,” shall be understood to include a simulated environment experienced by a user through one or more computer-generated sensory stimuli (e.g., sights, sounds, forces, and combinations thereof) and in which the user's reaction, in a physical space, to such sensory stimuli may result in changes in the simulated environment. In general, unless otherwise specified or made clear from the context, virtual reality environments may include any of various different levels of immersion for a user, ranging from complete immersion in computer-generated sensory stimuli to augmented reality environments including both virtual and real-world objects. As used herein, the terms “real-world,” “physical world,” “physical space,” and variations thereof generally refer to a physical setting separate from computer-generated stimuli. Thus, for example, a physical space may include the three-dimensional space occupied by, or in the vicinity of, a user playing a virtual reality game or, further or instead, may include real-world events that occur in physical reality (e.g., apart from computer-generated stimuli associated with the virtual reality environment).

In general, the devices, systems, and methods of the present disclosure may be used to provide virtual reality simulations associated with a variety of different implementations in which real-world data of a moving object forms a basis of a graphical representation of the moving object in a virtual reality environment, and the user may interact with the graphical representation of the moving object in the virtual reality environment. In the disclosure that follows, these devices, systems, and methods are described with respect to virtual reality simulations of the sport of cricket, which has dynamic aspects that serve as useful contexts for describing challenges addressed by the devices, systems, and methods of the present disclosure. For example, cricket bowling techniques may exhibit greater variation as compared to a sport like baseball and, as described in greater detail below, implementations described herein may facilitate simulating such variations in a virtual reality environment. Thus, as described in greater detail below, certain implementations may be used to simulate a variety of bowlers and bowling techniques implemented in cricket, as well as bowlers of different quality, skill, physical abilities, and so on. Additionally, or alternatively, certain implementations may be used to simulate a variety of settings for playing cricket, where such settings may have an effect on cricket play.

The use of cricket in the description that follows should be understood to be by way of example and not limitation. That is, unless otherwise specified or made clear from the context, it will be understood that the devices, systems, and methods described herein may be applicable to virtual reality simulations of other sports, games, and activities, or more generally to any other type of simulation. Thus, unless a contrary intent is indicated or clear from the context, the devices, systems, and methods of the present disclosure may be used for virtual reality simulation of other sports such as baseball, softball, Wiffle® ball, fencing, tennis, badminton, squash, racquetball, soccer, table tennis, and so on. Further or instead, the devices, systems, and methods of the present disclosure may be used for virtual reality simulation in other gaming aspects such as first-person combat (e.g., fighting or shooting) games. Still further, or instead, the devices, systems, and methods of the present disclosure may be used for virtual reality simulation in any of various different training contexts, such as medical training in which the user may carry out a simulated medical procedure in the virtual reality simulation.

In certain implementations, virtual reality simulations described herein may be based on data from one or more live-action sequences. For example, data from a live-action sequence may be incorporated (e.g., in a raw form or in a manipulated form) into a virtual reality simulation in a virtual reality environment, where a user may experience situations that are based at least in part on (e.g., closely resembling) situations that are occurring, or that have occurred, in the live-action sequence.

As used herein, unless otherwise specified or made clear from the context, the term “live-action sequence” or variations thereof shall refer to any of various different combinations of movements, physical actions, or circumstances occurring in the physical world. In some instances, such live-action sequences may be temporally coupled to a virtual reality simulation, occurring substantially simultaneously (e.g., within a few seconds or minutes) or in near real time (e.g., within less than a few seconds) relative to corresponding activity in a virtual reality simulation. Further, or instead, such live-action sequences may be temporally decoupled from a virtual reality simulation, such as may be useful for providing the virtual reality simulation to a user “on-demand.” In the context of the use of data from a live-action sequence of a sporting event, as described herein, the data may correspond to at least a portion of a non-simulated sporting event that is occurring, or that has occurred, in the physical world. This may include, for example, data recorded from a sporting event (e.g., through video recording, still-frame images, motion sensors, or a combination thereof).

It will thus be understood that the user(s) of devices, systems, and methods disclosed herein may include a human user seeking an immersive simulated experience (e.g., in a virtual reality sports simulation). This may include a user looking to experience a simulated activity without performing the activity in the physical world, e.g., because of lack of access to the activity or a parameter thereof (e.g., lack of a proper setting, lack of equipment, lack of requisite participants, and so on), or to mitigate the risk associated with the activity in question. The user may also or instead include a person interested in training or otherwise practicing or improving their skills for a particular simulated activity. In the context of sports, the user may include a person with varying skill levels or experience, e.g., a child, an adult, an amateur, a professional, and so on.

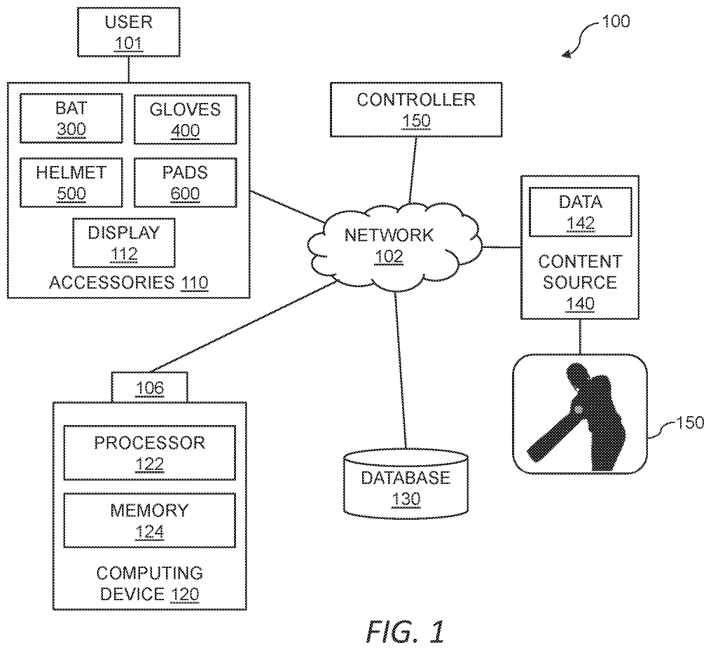

Referring now to FIG. 1, a system 100 may include one or more accessories 110, a computing device 120, a database 130, and a content source 140 in communication with one another (e.g., hardwired to one another, in wireless communication with one another, interconnected with one another over a data network 102, or a combination thereof). The content source 140 may include data 142 from a live action sequence 150. The database 130 may store the data 142 and, further or instead, other content useful for forming a virtual reality simulation. In use, the user 101 may interact with the system 100 through the accessories 110 (e.g., by wearing or wielding one or more of the accessories 110) to interact with a virtual reality environment provided by the computing device 120. For example, and as described in greater detail below, the accessories 110 may include one or more haptic devices to provide, to the user 101, force feedback emulating a real-world sensation that the user 101 would experience when playing a live-action sport corresponding to the type of simulated event. In this manner, the system 100 may create a relatively realistic experience for the user 101 of the system 100. For example, in the context of virtual reality sports simulation, the system 100 may create, for the user 101, an experience that more closely corresponds to the experience of playing a sport in the physical world. Further, and as described in greater detail herein, the system 100 may incorporate data 142 from the live action sequence 150 into the virtual reality environment, so that the user 101 may experience situations based at least in part on sequences from the live-action sequence 150.

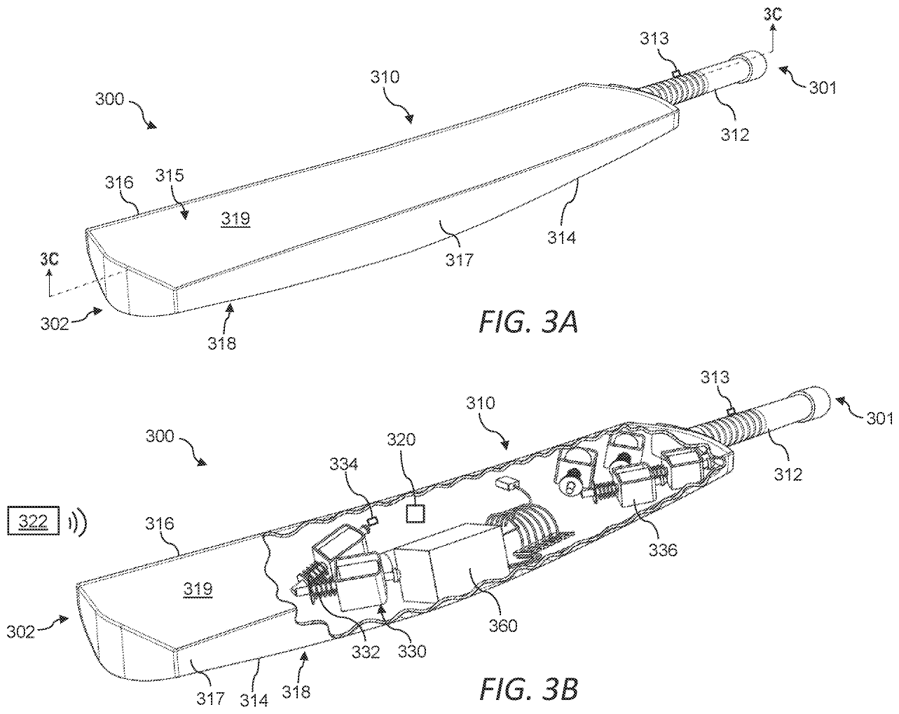

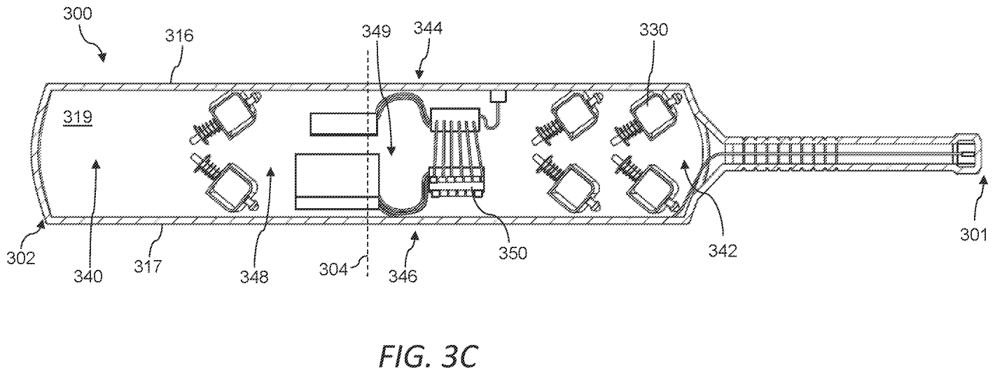

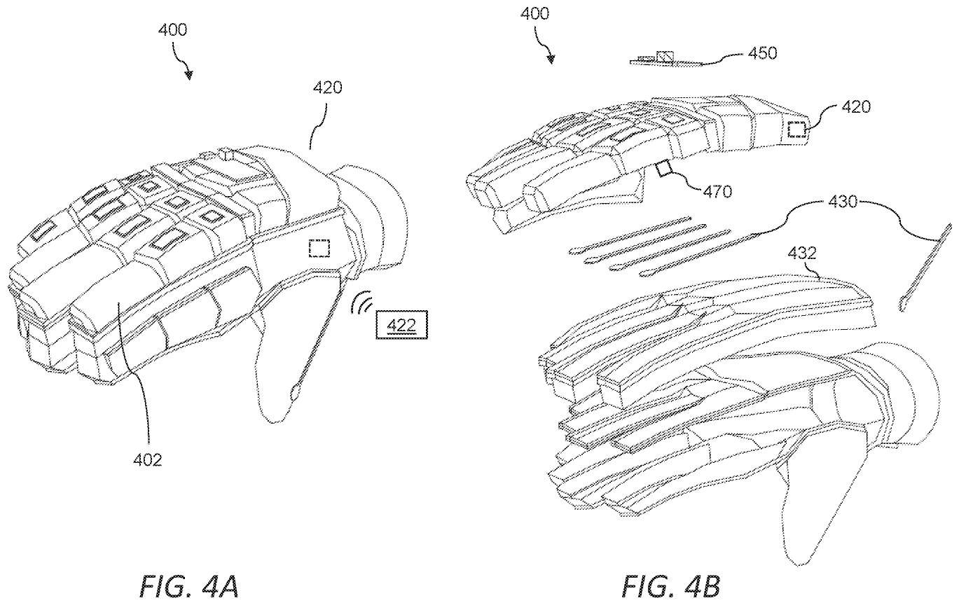

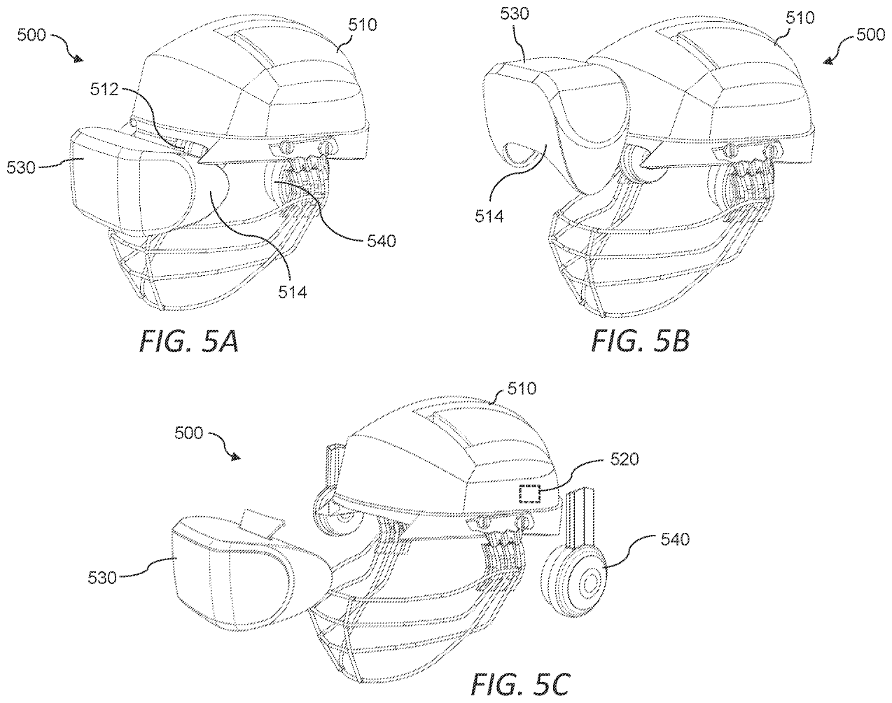

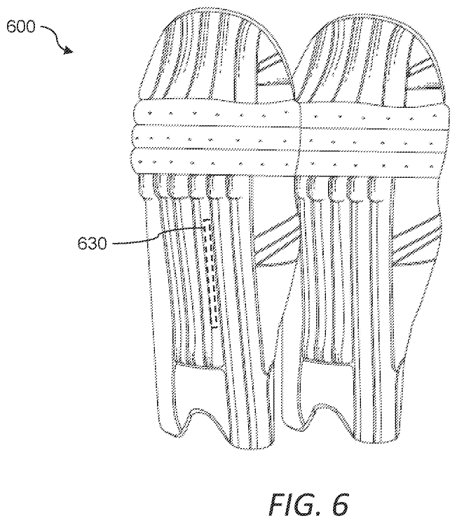

As described herein, the system 100 may facilitate virtual reality simulation, and more specifically, in some implementations, virtual reality sports simulation. As discussed above, an example of a sport that may benefit from virtual reality sports simulation facilitated by the system 100 is the sport of cricket. To this end, one or more of the accessories 110 described herein may correspond to accessories typically used when playing cricket. For example, the accessories 110 may include one or more of a bat 300 (see, e.g., FIGS. 3A, 3B and 3C), one or more gloves 400 (see, e.g., FIGS. 4A and 4B), a helmet 500 (see, e.g., FIGS. 5A-5C), and one or more pads 600 (see, e.g., FIG. 6). It will be understood, however, that other accessories (e.g., specific to other sports or activities) are also or instead possible. It will be further understood that, unless otherwise indicated or made clear from the context, attributes of a particular instance of the accessories 110 discussed herein may also or instead be included on another, different instance of the accessories 110 discussed herein.

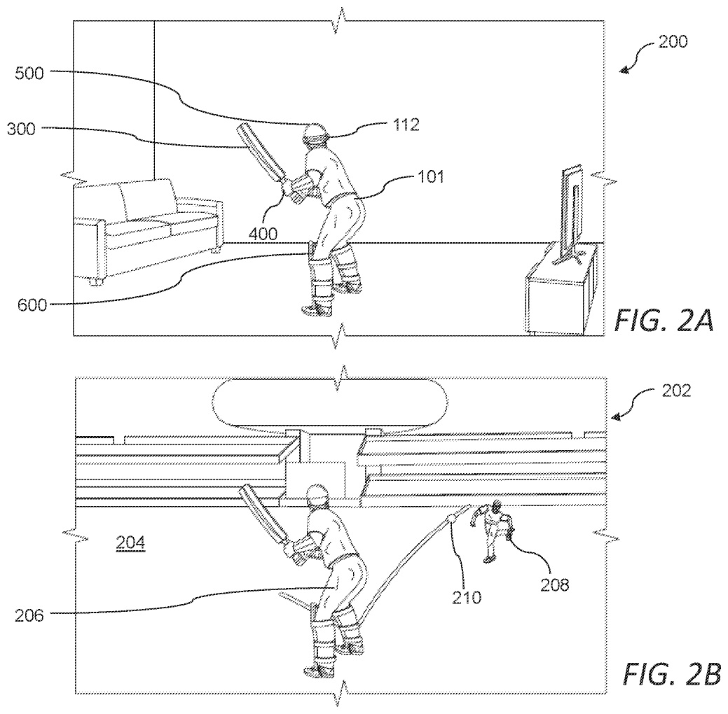

Referring now to FIGS. 2A and 2B, the user 101 in a physical space 200 may use the system 100 (FIG. 1) to interact with a virtual reality environment 202 as part of a virtual reality cricket simulation. For example, the user 101 may interact with the system 100 (FIG. 1) in a relatively controlled environment, such as at home, in a training facility (e.g., a sports training facility such as a batting cage), in a gaming facility (e.g., an arcade), and so on. For such a virtual reality simulation to become an immersive, realistic experience for the user 101, the user 101 may interact with one or more of the accessories 110 described above to receive haptic or other sensory feedback associated with the simulated sequence.

As shown in FIG. 2B, the virtual reality environment 202 may include a setting 204 simulated to resemble an environment corresponding to a particular activity. For example, in the context of a virtual reality cricket simulation, the setting 204 may include one or more of an infield, an outfield, a boundary, a sky, a stadium, a lighting condition (e.g., whether it is daytime or nighttime), and a weather condition. Further, the virtual reality environment 202 may include virtual representations (e.g., simulations) of participants in a simulated activity. That is, a user 101 may view simulations of a playing field, a bowler, fielders, as well as other aspects of live play of the sport of cricket. For example, the virtual reality environment 202 may include one or more virtual players, such as a first virtual player 206 representing a cricketer that is batting (the batsman) and a second virtual player 208 representing a cricketer that is bowling to the batsmen (the bowler). It will be understood that more or fewer virtual players may be represented in the virtual reality environment 202. Further, or instead, one or more of the virtual players may be a virtual representation (e.g., a first-person virtual representation) of the user 101 (FIG. 2A). Alternatively, or additionally, the user 101 may be represented by another component or object of the virtual reality environment 202 (e.g., human or non-human, animate or inanimate). In certain instances, the user 101 may not be specifically represented within the virtual reality environment 202. In the example shown in FIG. 2B, the user 101 is represented within the virtual reality environment 202 as the first virtual player 206, and is represented as a batsman.

Referring now to FIGS. 1, 2A, and 2B, the system 100 may provide the user 101 with a three-dimensional, panoramic view including, for example, a first-person view of a bowler and a surrounding environment, where the surrounding environment may include one or more elements found in a game setting (e.g., a stadium). As described in greater detail below, the second virtual reality player 208 may be a simulation of a real-world bowler, with movements of the second virtual reality player 208 created by at least partially replicating real-life movements of a bowler from stored video of past bowling performances. For example, the second virtual reality player 208 may be a digitized avatar of a generic bowler, with simulated movements of the second virtual reality player 208 created by animating body joints of the avatar using techniques such as key-framing, motion capture, or a combination thereof

To facilitate forming simulations described herein as immersive, realistic experiences for a user 101, it may be useful to provide the user 101 with relatively realistic force feedback corresponding to forces associated with the real-world activity being simulated. As described in greater detail below, such force feedback may be provided through one or more of the accessories 110. By way of example, when striking a bowled ball 210 in the virtual reality environment 202, the bat 300 wielded by the user 101 in the physical space 200 may provide the user 101 with the feeling of impacting the bowled ball 210, as if the impact occurred in the physical space 200. Continuing with this example, movement of one or more solenoids included in the bat 300, as described in further detail below, may transmit forces to hands of the user 101 gripping the bat 300. By way of further or alternative example, the system 100 may advantageously provide the user 101 with a physical stimulus in the physical space 200 when the user 101 is struck by a bowled ball 210 in the virtual reality environment 202. In certain implementations, it may be advantageous for the user 101 to experience the potential for being hit with a ball in the virtual reality environment 202. Thus, for example, the display 112 of the system 100 may represent hands or other portion of the body of the user 101 as the user 101 bats in the virtual reality environment 202, with the representations of one or more body parts of the user 101 in the virtual reality environment 202 providing the user 101 with a more realistic sensation of the potential for being struck (e.g., a user 101 may view a representation of one or more of their hands, head or helmet 500, hands or gloves 400, and so on). To facilitate presenting these and other realistic experiences to the user 101, the system 100 may generally include software, hardware, and accessories 110 operable in coordination with one another according to any one or more of the various different techniques described herein.

Additionally, or alternatively, the veracity of simulations described herein may benefit from including, in the virtual reality environment 202, one or more attributes mimicking the effects of the same attributes in the physical world. For example, in the context of cricket, certain bowlers may release a cricket ball such that the ball curves as the ball moves through the air—this is commonly referred to as “swing” in cricket—and the setting of the cricket match may affect this movement. By way of example, on a humid or cloudy day, a bowled ball 210 may be more likely to swing. These conditions may be commonly found in cooler-climates, such as the climates of England and New Zealand, and certain implementations described herein may be used to simulate such settings within the virtual reality environment 202. Further, certain implementations may to simulate a variety of conditions of a playing surface (referred to as the “pitch” in cricket). For example, a majority of balls in cricket hit the pitch before reaching the batsman, and thus the conditions of the pitch may play a significant role in the result of a bowled ball 210. For example, when a bowled ball 210 hits the pitch, the seam of the ball may react with the ground and create what is commonly referred to as “movement off the seam.” By way of example, greener pitches (playing surfaces between a batsman and a bowler that include grass) or relatively damp pitches may increase the likelihood of creating such movement off the seam. Relatively drier pitches, such as those typically found in India and Pakistan, may be more amenable to creating movement of a bowled ball 210 using spin, with bowlers using this technique commonly referred to as “spin bowlers.” In general, the system 100 may simulate one or more of the aforementioned conditions (and one or more other conditions or parameters) in the virtual reality environment 202 to achieve an immersive, realistic experience for the user 101.

Having provided an overall context for the system 100 and its use for virtual reality simulation, various aspects of the system 100 and techniques for forming immersive and useful virtual reality simulations using the system 100 will now be described. The description that follows is divided into sections describing hardware of the system 100 useful for forming the virtual reality environment 202 (I. HARDWARE), accessories useful for facilitating interaction between the user 101 and aspects of the virtual reality environment 202 (II. ACCESSORIES), and virtual reality simulations formed using the system 100 (III. SIMULATIONS). In general, it should be appreciated that these sections are presented for the sake of clarity of explanation and, unless otherwise specified or made clear from the context, these sections should not be considered to be limiting.

I. Hardware

As discussed above, the components of the system 100 shown for example in FIG. 1 may be connected to one another over a data network 102. The data network 102 may include any network(s) or internetwork(s) suitable for communicating data and control information among portions of the system 100. This may include public networks such as the Internet, private networks, telecommunications networks such as the Public Switched Telephone Network or cellular networks using third generation (e.g., 3G or IMT-2000), fourth generation (e.g., LTE (E-UTRA)) or WiMAX-Advanced (IEEE 802.16m) and/or other technologies, as well as any of a variety of corporate area or local area networks and other switches, routers, hubs, gateways, and the like that might be used to carry data among portions of the system 100. The data network 102 may thus include wired or wireless networks, or any combination thereof. One skilled in the art will also recognize that the components shown in the system 100 need not be connected by a data network 102, and thus may work in conjunction with one another, independently of the data network 102.

Communication over the data network 102, or other communication between components of the system 100, may be facilitated via one or more instances of a communications interface 106. The communications interface 106 may include, or may be connected in a communicating relationship with, a network interface or the like. The communications interface 106 may include any combination of hardware and software suitable for coupling the components of the system 100 to a remote device (e.g., a computing device 120) in a communicating relationship through a data network 102. By way of example and not limitation, this may include electronics for a wired or wireless Ethernet connection operating according to the IEEE 802.11 standard (or any variation thereof), or any other short or long-range wireless networking components. This may include hardware for short-range data communications such as Bluetooth or an infrared transceiver, which may be used to couple into a local area network or the like that is in turn coupled to a data network 102 such as the Internet. This may also or instead include hardware/software for a WiMAX connection or a cellular network connection (using, e.g., CDMA, GSM, LTE, or any other suitable protocol or combination of protocols). Additionally, or alternatively, a controller 150 may control participation by the components of the system 100 in any network to which the communications interface 106 is connected, such as by autonomously connecting to the data network 102 to retrieve status updates and the like.

In general, the display 112 may provide the user 101 with a visual representation (e.g., using one or more graphical representations or computer-rendered scenes) of the virtual reality environment 202. The display 112 may present to the user 101 one or more of still images, video data, or a combination thereof. To this end, the display 112 may include one or more of a two-dimensional display or a three-dimensional display. In some aspects, the display 112 may present a first-person view of a virtual representation of the user 101 to the user 101. In certain implementations, the display 112 may be associated with one or more of the accessories 110, such as the helmet 500 (see, e.g., FIGS. 5A-5C) worn by the user 101 during a simulation and described in greater detail below. In some implementations, at least a portion of the display 112 is included on, or forms part of, another component of the system 100, such as the computing device 120.

The computing device 120 may include, or otherwise be in communication with, a processor 122 and a memory 124. While the computing device 120 may be integrally formed in some instances, it should be appreciated that the computing device 120 may be advantageously distributed (e.g., with the processor 122 and the memory 124 supported on different portions of the system 100) in some applications. In general, the processor 122 may process the data 142 received from the content source 140 and, additionally or alternatively, the memory 124 may store the data 142 in any one or more of various different forms (e.g., raw, processed, or a combination thereof). The computing device 120 may also or instead be used to control one or more components of the system 100, and it will thus be understood that aspects of one or more instances of a controllers 150 described herein may also or instead apply to the computing device 120 and vice-versa.

In general, the computing device 120 may include any devices within the system 100 to manage, monitor, communicate with, or otherwise interact with other components in the system 100. This may include desktop computers, laptop computers, network computers, gaming systems or devices, tablets, smartphones, wearable devices, or any other device that can participate in the system 100 as contemplated herein. In an implementation, the computing device 120 (or a component thereof, e.g., the processor 122 or the memory 124) is integral with another component in the system 100 (e.g., the controller 150 or the accessories 110).

In some aspects, the computing device 120 may include a user interface. The user interface may include a graphical user interface, a text or command line interface, a voice-controlled interface, and/or a gesture-based interface. In implementations, the user interface may control operation of one or more of the components of the system 100, as well as provide access to and communication with one or more of the components of the system 100.

The database 130 may include any one or more of various different types of databases known in the art, including data stores, data repositories, or other memory devices or systems as well as combinations of the foregoing. In some implementations, the memory 124 of the computing device may act as the database 130, or vice-versa. In general, the database 130 may store the data 142 in a raw or processed format. In addition to, or instead of, raw or processed forms of the data 142 from the content source 140 or a live-action sequence 150 as described below, the data 142 may include instructions for controlling one or more components of the system 100, such as computer code, external or third-party information processed or manipulated for use in a virtual reality simulation program (e.g., by the computing device 120), or combinations thereof

As stated above, the content source 140 may include data 142 received from a live-action sequence 150. The live-action sequence 150 may include circumstances occurring in the physical world, such as a portion of a non-simulated sporting event that is occurring, or that has occurred, in the physical world. In this manner, data 142 from the live-action sequence 150 may include projectile data indicative of movement of a projectile launched by a player in the live-action sequence 150. Specifically, the data 142 may include information regarding a cricket ball in a cricket match such as location information, temporal information, spin information, speed information, or any one or more other types of information useful for presenting a trajectory of the cricket ball in the virtual environment 202. In some implementations, the data 142 may be suitable for inclusion in a virtual reality simulation program in a raw form (e.g., without further processing by the computing device 106). Alternatively, or additionally, the data 142 may be processed and/or manipulated before it is used as part of a virtual reality simulation or otherwise used in coordination with one or more components of the system 100 to carry out a virtual reality simulation. In some implementations, the data 142 is derived from recorded information from a sporting event, where the information is typically used by umpires/referees, broadcasters, coaches, players, and the like, to track the path or expected path of a ball to aid in making, challenging, or analyzing rulings on the field of play. For example, in the context of cricket, the data 142 may include information typically used to determine where a cricket ball would have struck if a batsman were not in the path of the ball. This data 142 may represent, in some instances, a starting-point for manipulation and incorporation into a system 100 as part of a virtual reality simulation.

The data 142 may be collected, stored, processed, or otherwise generally included on the content source 140. In some instances, the content source 140 may include a server with a memory storing the data 142, where such a server may provide an interface such as a web-based user interface for use of the data 142. The content source 140 may thus include a third-party resource.

The controller 150 may be electronically coupled (e.g., wired or wirelessly) in a communicating relationship with one or more of the other components of the system 100 and operable to control one or more of the other components of the system 150. In some aspects, the controller 150 may be part of another component of the system 150 (e.g., the computing device 120 or one or more of the accessories 110). Further, although one instance of the controller 150 is shown in FIG. 1, it will be understood that one or more different components of the system 100 may each include a respective instance of the controller 150, which may function independently or in a coordinated manner with one or more other components of the system 100 (e.g., with other instances of the controller 150). In general, the controller 150 may include, or otherwise be in communication with, an instance of the processor 122 and an instance of the memory 124, such as those shown in the figure as included on the computing device 120.

The controller 150 may include any combination of software and processing circuitry suitable for controlling the various components of the system 100 described herein including without limitation processors 122, microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and the like. In certain implementations, the controller 150 may include processing circuitry with sufficient computational power to provide related functions such as executing an operating system, providing a graphical user interface (e.g., to the display 112), to set and provide rules and instructions for operation of a component of the system 100, to convert sensed information into instructions, and to operate a web server or otherwise host remote operators and/or activity through a communications interface 106 or the like. In certain implementations, the controller 150 may include a printed circuit board, an Arduino controller or similar, a Raspberry Pi controller or the like, a prototyping board, or other computer related components.

The processor 122 may include an onboard processor for one or more of the computing device 120 and the controller 150. The processor 122 may be any as described herein or otherwise known in the art. In an implementation, the processor 122 is included on, or is in communication with, a server that hosts an application for operating and controlling the system 100.

The memory 124 may be any as described herein or otherwise known in the art. The memory 124 may contain computer code and may store data 142 such as sequences of actuation or movement of one or more of the accessories 110 or other hardware of the system 100. The memory 124 may contain computer-executable code stored thereon that provides instructions for the processor 122 for implementation in the system 100, for example, for controlling one or more components in the system 100. Thus, the memory 124 may include a non-transitory computer readable medium having stored thereon computer executable instructions for causing the processor 122 to carry out any one or more of the methods described herein such as to carry out all or a portion of a virtual simulation.

II. Accessories

Having provided an overall context for a system 100 for virtual reality simulation, various implementations of the accessories 110 will now be described. Unless otherwise specified, or made clear from the context, it will be generally understood that each of the accessories 110 may be used as part of the system 100 to carry out various different aspects of the virtual reality simulations described herein. As described in greater detail below, the accessories 110 may be used for improving an experience of virtual reality simulation, particularly in the context of virtual reality sports simulation.

Referring now to FIGS. 3A, 3B, and 3C, as described herein, an accessory for use in a virtual reality simulation system or a virtual reality game may include a bat 300. Although this accessory is described herein as a bat 300 (and more specifically as a cricket bat), it will be understood that this accessory may also or instead include another device for a virtual reality simulation system where features thereof (e.g., components that facilitate haptic feedback) may be advantageous or desired. For example, the features of the bat 300 described herein may be included as part of an accessory including or representing a weapon (e.g., a sword), a baton, a stick, a club, and so forth. Similarly, although the bat 300 is described herein as providing haptic feedback to simulate contact with a projectile such as a ball (e.g., a cricket ball), the haptic feedback may also or instead simulate contact with other objects, projectiles, or otherwise, whether static or moving.

The bat 300 may include a housing 310 having a handle 312 and a body 314 extending from the handle 312, a tracking device 320, one or more solenoids 330 disposed within the housing 310, and a controller 350.

The bat 300 may be wielded by a user 101 in the physical world while the user 101 is participating in a virtual reality simulation. In use, and when held by the user 101, the bat 300 may simulate impact caused by a projectile striking the bat 300 (and vice-versa) without the bat 300 in the physical world ever striking such a projectile (e.g., the bat 300 may simulate the impact of a cricket bat striking a cricket ball during play in the physical world). The simulated impact may be provided through actuation of one or more of the solenoids 330, which in turn may cause the bat 300 to vibrate as a form of haptic feedback for a user 101 holding the bat 300. The haptic feedback provided by the bat 300 to the user 101 may vary based on a physical parameter of the bat 300 (such as the shape of the bat 300, the size of the bat 300, and the material of the bat 300), and/or a parameter of a contact event that occurs within a virtual reality environment 202. The contact event may include contact between virtual representations of the bat 300 and a projectile (e.g., a virtual representation of a cricket ball) within the virtual reality environment 202. In this manner, the haptic feedback provided by the bat 300 to the user 101 may represent one or more different simulated contact scenarios based on, for example, the location where a virtual representation of the bat 300 made contact with the virtual representation of a projectile, or other factors related to a contact event such as a speed of the virtual representation of the projectile, spin of the virtual representation of the projectile, speed of the bat 300 being swung by the user 101 (or a relationship between the speed of the bat 300 in physical world to the speed of the bat 300 in the virtual reality environment 202), an angle of the bat 300 being swung by the user 101 (or a relationship between the angle of the bat 300 in physical world to the angle of the bat 300 in the virtual reality environment 202), exit speed or exit angle of the virtual representation of the projectile after contact with the virtual representation of the bat 300, and so forth.

The bat 300 may generally include a size and shape that substantially resembles a typical cricket bat. For example, and as discussed above, the housing 310 may have a handle 312 and a body 314 extending from the handle 312, where the handle 312 is sized and shaped for holding by the user 101 and where the body 314 includes one or more surfaces configured for striking a projectile (e.g., a cricket ball). Specifically, the bat 300 may include a first end 301 having the handle 312, a second end 302 disposed away from the handle 312, a first surface 315 bounded by a top edge 316 and a bottom edge 317, and a second surface 318 disposed opposite the first surface 318. In some instances, the first surface 315 may include a face 319 structurally configured to contact a cricket ball and the second surface 318 may include one or more of a bulge, a swell, and a spline, where one or more of these features may be found on typical cricket bats.

The housing 310 may be made of similar materials relative to a typical cricket bat. For example, the housing 310 may be made of one or more of carbon fiber and fiberglass. The housing 310 may also or instead include wood or a composite material that resembles wood in one or more of appearance, feel, weight, and so on.

In general, the size of the bat 300 may resemble that of a typical cricket bat as discussed above. Thus, in certain implementations, the bat 300 may have a length of no more than about 38 inches (about 965 mm), a width of no more than about 4.25 inches (about 108 mm), an overall depth of no more than about 2.64 inches (about 67 mm), and edges of no more than about 1.56 inches (about 40 mm).

In some implementations, one or more portions of the bat 300 receive or otherwise cooperate with one or more parts of a third-party system, such as a video game system or a video game console. For example, the handle 312 of the bat 300 may define a void for inserting at least a portion of a video game controller or other component of a video game system.

The tracking device 320 may be operable to track a position of the housing 310 (e.g., a specific portion of the housing 310 or the bat 300 generally). The tracking device 320 may communicate the position to a virtual reality environment 202 (see, e.g., FIG. 2B) in substantially real time (e.g., having a time delay of no more than 25 milliseconds). To this end, the tracking device 320 may be monitored by one or more sensors 322 (e.g., external sensors such as one or more lasers that perform predetermined sweeps of a physical space where the bat 300 is being used). The tracking device 320 may work in conjunction with the controller 350 so that simulated movement of the bat 300 is provided within the virtual reality environment 202 in substantially real time based on information provided by the tracking device 320 in the physical world. As discussed herein, the bat 300 may represent one of the accessories 110 in the system 100 described with reference to FIG. 1, and thus the bat 300 may also or instead work in conjunction with one or more other components of that system 100. For example, the bat 300 may include a communications interface 106 to communicate with a processor 122 that is executing a virtual reality cricket game within a virtual reality environment 202, where the processor 122 is configured to receive a position of the housing 310 and to render the position of the housing 310 within the virtual reality environment 202 in substantially real time.

As discussed above, the bat 300 may include one or more solenoids 330 that are actuatable to provide force feedback to a user 101 of the bat 300. To that end, the controller 350, which may be the same or similar to any of the controllers described herein (e.g., the controller 150 of FIG. 1), may be in communication with the plurality of solenoids 330 for controlling actuation thereof. Specifically, the controller 350 may receive information related to location-specific contact between virtual representations of the bat 300 and a projectile (e.g., a virtual representation of a cricket ball) within the virtual reality environment 202 and to selectively actuate one or more of the plurality of solenoids 330 to exert a force based on the location-specific contact. The force exerted by one or more of the plurality of solenoids 330 may be directed on the housing 310 of the bat 300 such that a user 101 holding the handle 312 (or other portion) of the bat 300 feels the force as haptic feedback. Thus, in some implementations, the solenoids 330 may exert a force on the handle 312 of the bat 300 in a relative indirect manner (e.g., from the body 314 that is connected to the handle 312). Alternatively, one or more of the solenoids 330 may be positioned within the handle 312 of the bat 300, or may be coupled to the handle 312 of the bat 300, to directly apply a force to the handle 312.

The solenoids 330 may be positioned within the housing 310 in a predetermined arrangement, orientation, and general configuration so that one or more of the solenoids 330, when actuated, may provide haptic feedback to a user 101 of the bat 300 that simulates a predetermined contact scenario or event. Similarly, the number of solenoids 330 included within the housing 310, and the number of solenoids 330 that are actuated by the controller 350, may facilitate simulation of one or more specific, simulated contact scenarios. Each of these simulated contact scenarios may include, for example, a virtual representation of a ball striking a virtual representation of the bat 300 in a different location on the bat 300 or at a different simulated force or direction of impact, such that there is different haptic feedback provided to a user 101 for different location specific and/or force specific contact between virtual representations of the bat 300 and a ball within the virtual reality environment 202.

By way of example, one or more of the simulated contact scenarios may include simulation of a ball striking the bat 300 on (i) a tip 340 of the bat 300 defined by a distal end of the face 319 disposed substantially adjacent to the second end 302 of the bat 300, (ii) a base 342 of the bat 300 defined by a proximal end of the face 319 disposed substantially adjacent to the handle 312, (iii) an upper contact area 344 on or adjacent to the top edge 316 of the bat 300, (iv) a lower contact area 346 on or adjacent to the bottom edge 317 of the bat 300, (v) a “sweet spot” 348 on the face 319 disposed between a centerline 304 of the face 319 and the distal end of the face 319, and (vi) a middle-hit area 349 of the face 319 disposed between the sweet spot 348 and the proximal end of the face 319. Although these specific examples of predetermined contact scenarios are provided above, it will be understood that other contact scenarios are also or instead possible for simulation.

The solenoids 330 may be positioned within the housing 310 and specifically actuated to facilitate haptic feedback for a user 101 wielding the bat 300 for the above-identified exemplary simulated contact scenarios. For example, in certain implementations, one or more solenoids 330 may be disposed adjacent to the second end 302 of the bat 300 and are configured to actuate during simulated contact scenario (i) discussed above; one or more solenoids 330 may be disposed adjacent to the first end 301 of the bat 300 and are configured to actuate during simulated contact scenario (ii) discussed above; one or more solenoids 330 may be disposed adjacent to the top edge 316 of the bat 300 and are configured to actuate during simulated contact scenario (iii) discussed above; and one or more solenoids 330 may be disposed adjacent to the bottom edge 317 of the bat 300 and are configured to actuate during simulated contact scenario (iv) discussed above.

Simulated contact scenario (v) discussed above may represent an ideal contact event between a cricket bat and a cricket ball, such as contact made in the sweet spot 348 of the bat 300. Thus, in some aspects, all of the solenoids 330 in the plurality of solenoids 330 may be configured to actuate during this simulated contact scenario to alert a user 101 that they have made contact in the sweet spot 348 of a virtual representation of the bat 300. Also, in some implementations, one or more of the solenoids 330 may be configured to actuate in a plurality of different power modes, where a power mode corresponds to the force exerted by a solenoid 330. Some examples of such power modes may include a low-power mode and a high-power mode, where the low-power mode exerts less force than the high-power mode. To this end, in an implementation, all of the solenoids 330 may actuate in a low-power mode during simulated contact scenario (v) discussed above to create the feeling of a relatively smooth and desirous impact for the user 101. Similarly, because simulated contact scenario (vi) discussed above may represent a slight “mis-hit” contact event between a cricket bat and a cricket ball, in some aspects, all of the solenoids 330 in the plurality of solenoids 330 may be configured to actuate during this simulated contact scenario to alert a user 101 that such an event has occurred, but in a different power mode from simulated contact scenario (v)—e.g., a high-power mode such that the feedback is relatively jarring to a user 101 indicating the slight mis-hit. Other power modes are also or instead possible for actuation of the solenoids 330.

It will be understood that other arrangements for the solenoids 330, and other actuation techniques, sequences, and scenarios for the solenoids 330 are also or instead possible. However, in general, the physical arrangement of the plurality of solenoids 330 within the housing 310 may provide a predetermined force distribution for certain location-specific or force-specific contact between virtual representations of the bat 300 and a projectile within the virtual reality environment 202.

An example of a specific arrangement for the solenoids 330 is shown in FIGS. 3B and 3C. In general, the physical arrangement of the plurality of solenoids 330 within the housing 310 may provide a predetermined center of gravity for the bat 300 (e.g., one that substantially resembles the predetermined center of gravity for a typical cricket bat having a similar size and shape). Similarly, the housing 310 of the bat 300, with the plurality of solenoids 330 included therein, may be weighted to provide a relatively similar feel to a typical cricket bat having a similar size and shape (e.g., while holding the bat 300 and during a swing by the user 101). For example, a typical cricket bat may have a weight between about 2.0 lbs. and about 3.5 lbs., and thus the housing 310 and components included therein may be selected to have a cumulative weight between about 2.0 lbs. and about 3.5 lbs.

As discussed herein, each of the plurality of solenoids 330 may be positioned in a predetermined orientation (e.g., relative to one another or relative to one or more surfaces of the housing 310 of the bat 300). For example, the predetermined orientation of at least one of the plurality of solenoids 330 may be substantially normal to a plane of the face 319 of the bat 300. Also, or instead, the predetermined orientation of at least one of the plurality of solenoids 330 may be at a non-ninety-degree angle relative to a plane of the face 319 of the bat 300. Thus, one or more of the plurality of solenoids 330 may have an axis of linear actuation disposed at an angle between about 1-degree and about 89-degrees relative to a plane of the face 319 of the bat 300. For example, the predetermined orientation of at least one of the plurality of solenoids 330 may have an axis of linear actuation disposed at an angle of about 35 degrees offset from a plane of the face 319 of the bat 300 (or another surface of the bat 300). Also, or instead, at least one of the plurality of solenoids 330 may be disposed substantially level with a center plane of the bat 300. By way of further example, the predetermined orientation of the plurality of solenoids 330 may include at least two of the plurality of solenoids 330 having respective axes of linear actuation at least about 70 degrees opposed to one another and no more than about 145 degrees offset from a plane of the face 319 of the bat 300 (or another surface of the bat 300). Other arrangements and orientations are also or instead possible.

In some implementations, the number of the plurality of solenoids 330 includes at least six solenoids 330 as shown in FIGS. 3B and 3C. For example, at least two of the solenoids 330 may be disposed adjacent to the first end 301 of the bat 300 and at least another two of the solenoids 330 may be disposed adjacent to the second end 302 of the bat 300, where two other solenoids 330 are disposed therebetween. However, it will be understood that more than six solenoids 330 or less than six solenoids 330 are possible without departing from the scope of this disclosure, and the number, positioning, and orientation of the solenoids 330 may vary without departing from the scope of this disclosure.

Thus, in general, one or more of the solenoids 330 may be disposed within the body 314 of the housing 310 as described herein. However, one or more of the solenoids 330 may also or instead be disposed in another portion of the bat 300 such as the handle 312. Similarly, in some implementations, the handle 312 may include a protrusion 313 engaged with a solenoid 330 for conveying haptic feedback to a user's hands when the user is gripping the handle 312 during exertion of a force based on a location-specific contact event. Other mechanical or structural features are also or instead possible for inclusion on the bat 300 for conveying haptic feedback to a user's hands when the user is gripping the handle 312 during exertion of the force based on a location-specific or force-specific contact event.

Generally, one or more of the solenoids 330 may include a movable member 332, such as a movable arm, where movement of the movable member 332 facilitates haptic feedback as described herein. Thus, one or more of the solenoids 330 may include a linear actuator or similar. A movable member 332 of one or more of the solenoids 330 may be spring-loaded or otherwise biased such that, upon release, the movable member 332 extends or otherwise moves to create a force or vibration corresponding to haptic feedback. For example, the movable member 332, upon movement thereof, may impact a contact surface 334 causing vibration in the bat 300. The contact surface 334 may be a surface of the housing 310 or a separate surface disposed within the housing 310. Stated otherwise, in some implementations, the bat 300 may include a contact surface 334 disposed adjacent to at least one of the plurality of solenoids 330, where at least a portion of this solenoid 330 (e.g., a movable member 332 thereof) is structurally configured to contact the contact surface 334 when actuated. Also, or instead, movement of the movable member 332 itself may provide the force or vibration corresponding to haptic feedback (e.g., without contacting a surface of the bat 300).

Movement of the movable member 332 of a solenoid 330 may be facilitated by a motor 336 included on the solenoid 330 (e.g., a direct current motor). In certain implementations, one or more of the solenoids 330 is capable of providing about eight kilograms of force. However, because a typical cricketer may experience about 40-55 kilograms of force when batting, it will be understood that more powerful solenoids 330 are also or instead possible without departing from the scope of this disclosure.

The bat 300 may further include one or more power sources 360 within the housing 310 that are in electrical communication with one or more powered components of the bat 300 (e.g., one or more of the plurality of solenoids 330 and the controller 350). The one or more power sources 360 may include a battery (e.g., a rechargeable battery). For example, a power source 360 may include a wireless rechargeable battery that can be recharged using a short-range or long-range wireless recharging system. The power source 360 may also or instead be coupled to a port (e.g., a USB port) for connection to an electrical outlet or similar for charging.

Referring now to FIGS. 4A and 4B, an accessory for use in a virtual reality simulation system or a virtual reality game may include a glove 400. As described above, although this accessory is described herein in the context of a cricket simulation, it will be understood that this accessory may also or instead be adapted for use in other contexts.

The glove 400 may be sized and shaped to receive at least one portion of a hand of a user 101. For example, the glove 400 may be structurally configured to receive the entire hand of a user 101, or one or more fingers and the thumb of the user 101. The glove 400 may be adapted for use with a cooperating accessory, for example, another glove such that each of a user's hands are engaged with such accessories. The glove 400 may resemble a typical glove that is worn for protection, grip, and comfort by a cricket batsman. Thus, the glove 400 may include padding 402 disposed on or within at least a portion of the glove 400. Similar to other accessories described herein, the glove 400 may include a tracking device 420, one or more haptic feedback actuators 430, and a controller 450.

The tracking device 420 may be the same or similar to other tracking devices described herein (e.g., the tracking device 320 with reference to the bat 300 shown in FIGS. 3A, 3B, and 3C). In general, the tracking device 420 may be coupled to the glove 400 and operable to track a position of the glove 400 (e.g., to communicate the position to the virtual reality environment 202 in substantially real time). Thus, similar to the tracking device 320 of the bat 300, the tracking device 420 may be monitored by one or more sensors 422. As discussed herein, the glove 400 may represent one of the accessories 110 in the system 100 described with reference to FIG. 1, and thus the glove 400 may also or instead work in conjunction with one or more other components of that system 100. For example, the glove 400 may include a communications interface 106 to communicate with a processor 122 that is executing a virtual reality cricket game within the virtual reality environment 202, where the processor 122 receives a position of the glove 400 and renders the position of the glove 400 within the virtual reality environment 202 in substantially real time. In this manner, the virtual reality environment 202 may include a virtual representation of the glove 400 viewable by the user 101.

In some implementations, the glove 400 is flexible to grasp a bat, such as the bat 300 described above. To this end, the tracking device 430 may be configured to detect and communicate finger flexion, or thumb flexion, of the user 101 wearing the glove 400. The tracking device 430 may also or instead be configured to detect and communicate an orientation of the glove 400, or other position and movement information.

The one or more haptic feedback actuators 430 may be coupled to the glove 400 in a predetermined arrangement, where one or more of the haptic feedback actuators 430 are actuatable to transmit forces to at least one portion of the hand of the user 101 in the glove 400. Thus, in use, the haptic feedback actuators 430 may transmit a force to a wearer of the glove 400 to simulate a contact scenario that takes place within the virtual reality environment 202. The haptic feedback actuators 430 may be disposed in one or more locations of the glove 400. For example, the haptic feedback actuators 430 may be dispersed throughout different locations within the glove 400 corresponding to different regions of a user's hand when wearing the glove 400. This may include implementations where one or more haptic feedback actuators 430 are disposed along one or more portions of the glove 400 sized and shaped to receive a finger of a wearer, a thumb of a wearer, a palm of a wearer, a backside of a wearer's hand, and combinations of the foregoing.

The haptic feedback actuators 430 may include, or be formed on, an insert 432 disposed within the glove 400. The insert 432 may be disposed within padding 402 of the glove 400 or between layers of padding 402. To this end, the padding 402 may include a top layer and a bottom layer, with one or more haptic feedback actuators 430 disposed in-between these layers.

The controller 450 may be the same or similar to other controllers described herein. In general, the controller 450 may be in communication with the tracking device 420, one or more of the haptic feedback actuators 430, and a virtual reality environment 202 (FIG. 2B), for example, e.g., for controlling one or more aspects of one or more of these components. For example, the controller 450 may be configured to: receive, from the tracking device 420, a position of the tracking device 420; transmit the position of the tracking device 420 to the virtual reality environment 202; receive, from the virtual reality environment 202, an indication of force on a virtual glove (corresponding to the glove 400 in the physical world) in the virtual reality environment 202; and actuate one or more haptic feedback actuators 430 on the glove 400 to simulate the force on the virtual glove in the virtual reality environment 202.

By way of example, the indication of force on the virtual glove in the virtual reality environment 202 may correspond to a ball striking a bat being held by the hand of a user 101. In this manner, when such contact between a virtual bat and a virtual ball is made within the virtual reality environment 202, a user 101 in the physical world may feel a representative force in the glove 400 through actuation of one or more of the haptic feedback actuators 430. By way of further example, the indication of force on the virtual glove in the virtual reality environment 202 may also or instead correspond to a ball striking the glove 400. In this manner, when such contact between a virtual ball and a virtual glove is made within the virtual reality environment 202, a user 101 in the physical world may feel a representative force in the glove 400 through actuation of one or more of the haptic feedback actuators 430.

In some aspects, the glove 400 is the only accessory providing such haptic feedback. In other aspects, the glove 400 works in conjunction with one or more other accessories (e.g., the bat 300 described above) to provide a more realistic feel for the user 101. To this end, one or more of the haptic feedback actuators 430 may operate in coordination with one or more haptic devices on another accessory wielded by the user 101 (e.g., the solenoids 330 included on a bat 300 held by the user 101).

To differentiate between different simulated contact scenarios (e.g., a virtual ball striking a virtual bat or virtual glove), different haptic feedback actuators 430 may actuate and/or the haptic feedback actuators 430 may actuate in different power modes to create different feedback. Further, the glove 400 may facilitate feedback that is location specific or force specific within the glove 400 itself. For example, the haptic feedback actuators 430 may be disposed throughout different portions of the glove 400, such that certain haptic feedback actuators 430 in certain designated locations may be actuated depending upon the location of contact in a simulated contact scenario. Thus, one or more of the haptic feedback actuators 430 may be operable to adjust feedback based on a parameter in the virtual reality environment 202, where such a parameter may include one or more of a virtual bat selected by the user 101, a location on the virtual bat where a virtual ball makes contact in the virtual reality environment 202, a vertical displacement between the virtual bat and the virtual ball in the virtual reality environment 202, a location on the virtual glove where a virtual ball makes contact in the virtual reality environment 202, a force of impact, and so on. Similarly, one or more of the haptic feedback actuators 430 may be operable to adjust feedback based on an attribute of one or more of a virtual ball and a virtual bat in the virtual reality environment 202, where such an attribute may include one or more of ball speed, ball spin (if any), bat speed, bat angle, an exit speed of a bat held by the user 101, and an exit angle of the bat. Such an attribute for the virtual bat may directly correspond to motion and use of a bat 300 or other accessory in a physical space.

It will be understood that the glove 400 (and/or another accessory described herein) may also or instead include one or more other sensors 470. These sensors 470 may include one or more of the following: a force sensor, a contact profilometer, a non-contact profilometer, an optical sensor, a laser, a temperature sensor, a motion sensor, an imaging device, a camera, an encoder, an infrared detector, a weight sensor, a sound sensor, a light sensor, a sensor to detect a presence (or absence) of an object, and so on.

Referring now to FIGS. 5A, 5B, and 5C, an accessory for use in a virtual reality simulation system or a virtual reality game may include a helmet 500. As described above, although this accessory is described herein in the context of a cricket simulation, it will be understood that this accessory may also or instead be adapted for use in other contexts.

The helmet 500 may include a shell 510 that is positionable about at least one portion of a head of a user 101, a display 530 coupled to the shell 510, an audio device 540 coupled to the shell 510, and a tracking device 520 coupled to the shell 510.

The shell 510 may be sized and shaped to substantially mimic, in both look and feel, a cricket batsman's helmet. That is, the shell 510 may resemble a real-world cricket helmet worn by a typical batsman for safety. For example, to more realistically provide a cricket gaming experience, the shell 510 may include an actual, real-world cricket helmet adapted to accommodate one or more of the display 530, the audio device 540, and the tracking device 520.

The display 530 may be the same or similar to any of the displays described herein or otherwise known in the art of virtual reality simulation. For example, the display 530 may be included on a virtual reality head mounted display (HMD) visor.

As shown in FIGS. 5A and 5B, the display 530 may be movable between different positions. For example, and as shown in FIG. 5A, the display 530 may be placed in a first position where the display 530 is viewable by a user 101 with the shell 510 positioned about at least a portion of the head of the user 101. And as shown in FIG. 5B, the display 530 may be placed in a second position where the display 530 is not obstructing at least part of a user's vision with the shell 510 positioned about at least a portion of the head of the user 101. To accommodate the display 530 being movable between different positions, the display 530 may be pivotable, slidable, extendable, and so on, relative to the shell 510. For example, and as shown in FIGS. 5A and 5B, the helmet 500 may include a pivoting joint 512 that couples the display 530 to the shell 510. More specifically, the helmet 500 may include a display mount 514 coupled to the shell 510 that is sized and shaped to receive the display 530 therein or thereon, where the display mount 514 includes or is otherwise coupled to a pivoting joint 512 or other connection (e.g., a hinge) facilitating movement of the display 510 relative to the shell 510. Thus, at least a portion of the display mount 514 may be movable relative to the shell 510. For example, the display mount 514 may be movable to place the display 510 in the first position shown in FIG. 5A and the second position shown in FIG. 5B, or other positions.

The display 530 may also or instead be removable and replaceable from the display mount 514, such as where the display 530 is included on a mobile computing device (e.g., a smartphone) and the mobile computing device is removably mountable to the helmet 500 via the display mount 514.

The audio device 540 may be operable to provide audio output from the virtual reality environment 202 to the user 101 with the shell 510 positioned about a portion of the head of the user 101. In some implementations, the audio device 540 includes headphones or earbuds. The audio device 540 may be integral with the shell 510.

The tracking device 520 may be the same or similar to any of the tracking devices described herein or otherwise known in the art of virtual reality simulation. In general, the tracking device 520 may be operable to track a position of the helmet 500, and to communicate the position to a virtual reality environment 202 in substantially real time. As discussed herein, the helmet 500 may represent one of the accessories 110 in the system 100 described with reference to FIG. 1, and thus the helmet 500 may also or instead work in conjunction with one or more other components of that system 100. For example, the helmet 500 may include a communications interface 106 to communicate with a processor 122 that is executing a virtual reality cricket game within the virtual reality environment 202, where the processor 122 is configured to receive a position of the helmet 500 and to render the position of the helmet 500 within the virtual reality environment 202 in substantially real time. In this manner, the virtual reality environment 202 may include a virtual representation of the helmet 500 viewable by the user 101. The tracking device 520 may be disposed on or within the shell 510 of the helmet 500.

It will be understood that the helmet 500 may also or instead include any of the features described above with reference to other accessories 110 in the system 100 described with reference to FIG. 1 or elsewhere in this disclosure. Thus, the helmet 500 may include sensors, solenoids or other haptic feedback devices, and so on.

In addition to the accessories described above for use in a virtual reality simulation system or a virtual reality game, which are set forth by way of example and not of limitation, other accessories are also or instead possible. One such accessory includes the pads 600 shown in FIG. 6. The pads 600 may include one or more of the features described herein that aid in a virtual reality simulation becoming more of an immersive, realistic experience for a user. For example, the pads 600 may include one or more haptic feedback actuators 630 that facilitate a user 101 to feel relatively realistic force feedback corresponding to forces that may be experienced when partaking in an activity in the real world that is being simulated in a virtual reality environment 202 (FIG. 2B).

In general, the pads 600 may include a wearable accessory, and although shown as typical padding that a cricket player might wear during a cricket match, it will be understood that other wearable accessories are contemplated herein. This may include other padding-type or add-on accessories, as well as more typical wearable clothes such as hats, pants, shirts, and so on.

In the context of a cricket simulation, one or more haptic feedback actuators 630 in the pads 600 may actuate to simulate a batsman being struck by a bowled ball (e.g., when such an instance occurs in a virtual environment as described herein).

III. Simulation

Having provided an overall context for a system 100 for virtual reality simulation (see, e.g., FIG. 1) and various hardware components that may be included in such a system (see, e.g., FIGS. 2A-6), various simulation techniques will now be described. It will be understood that the following virtual reality simulation techniques may be used for improving an experience of virtual reality simulation, and more particularly, for improving an experience of virtual reality sports simulation. To that end, it will be understood that one or more of the following virtual reality simulation techniques may be used in conjunction with one or more of the hardware accessories or other components described herein.

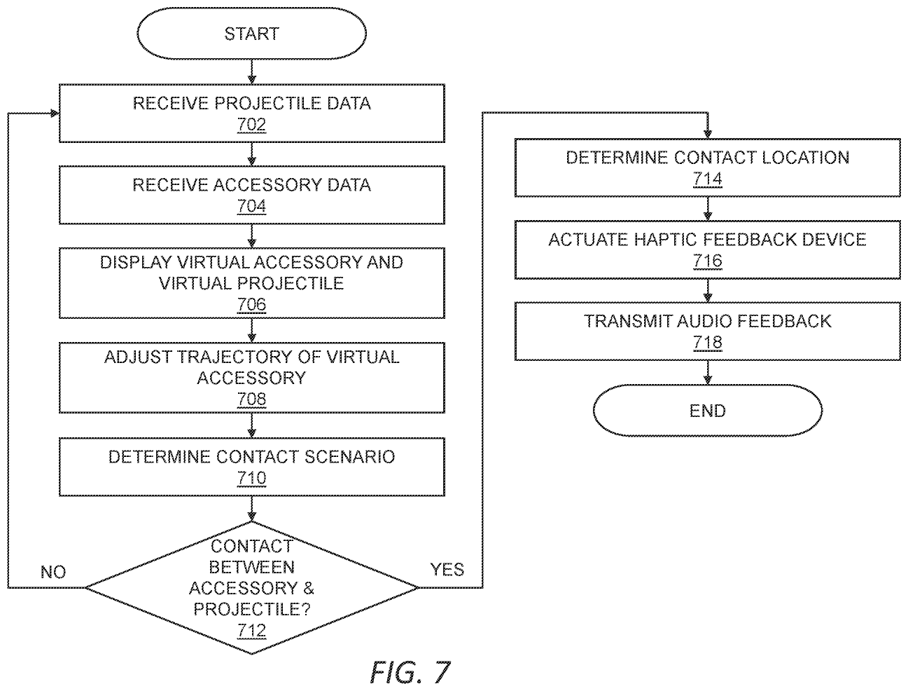

FIG. 7 is a flow chart of an exemplary method 700 of operating a virtual reality game. Unless otherwise specified or made clear from the context, it should be appreciated that the exemplary method 700 may be carried out using any one or more of the devices, systems, and methods described herein. Thus, for example, the exemplary method 700 may be carried out using the system 100 (see, e.g., FIG. 1) and, more specifically, may be carried out to create a realistic virtual reality simulation for an end user 101 incorporating one or more of the accessories 110 described herein (e.g., the bat 300 of FIGS. 3A-3C). It will thus be understood that, while the exemplary method 700 may emphasize use of a bat 300 as the accessory 110 being used, the exemplary method 700 may be adapted with any of the other accessories 110 discussed herein.

As shown in step 702, the exemplary method 700 may include receiving projectile data. The projectile data may be related to a virtual projectile within a virtual reality environment, which, as discussed in more detail below, may be directly or indirectly correlated to a real-world projectile in a live-action sequence. The projectile data may include temporal data related to the arrival of a virtual projectile within a predetermined volume adjacent to a virtual player in a virtual reality environment, and spatial data related to a trajectory of the virtual projectile in the virtual reality environment.

As shown in step 704, the exemplary method 700 may include receiving accessory data including movement of an accessory in a physical space (e.g., an accessory held by, worn by, or otherwise wielded by a user of a virtual reality simulation). The accessory data may correspond to movement of a virtual accessory of a virtual player within the virtual reality environment.

As shown in step 706, the exemplary method 700 may include displaying the virtual accessory and the virtual projectile on a display of a virtual reality simulation system (e.g., a display that is viewable by a user). The exemplary method 700 may also or instead include simulating tracked movement of the accessory within the virtual reality environment.

As shown in step 708, the exemplary method 700 may include adjusting a trajectory of the virtual accessory based on additional tracked movement of the accessory. Thus, for example, if a user adjusts movement of the accessory in the real-world, the virtual accessory of the virtual player within the virtual reality environment may be adjusted in a similar fashion.

As shown in step 710, the exemplary method 700 may include determining, based on a comparison of the accessory data and the projectile data, a contact scenario between the virtual accessory and the virtual projectile within the virtual reality environment. The contact scenario may be any of the simulated or predetermined contact scenarios discussed herein.

As shown in step 712, the exemplary method 700 may include determining whether the virtual accessory will contact the virtual projectile within the virtual reality environment. When it is determined that no contact is made, or will be made, between the virtual accessory and the virtual projectile within the virtual reality environment, the exemplary method 700 may include repeating one or more of the steps of receiving projectile data, receiving accessory day, and so on, until it is determined that there is or will be contact between the virtual accessory and a virtual projectile within the virtual reality environment. It will also be understood that other steps in the exemplary method 700 may still be performed, however, even when it is determined that no contact is made, or will be made, between the virtual accessory and the virtual projectile within the virtual reality environment, such as transmitting appropriate audio feedback (e.g., a sound of a projectile passing by a virtual player without making contact with the virtual accessory). When it is determined that contact is made, or will be made, between the virtual accessory and a virtual projectile within the virtual reality environment, the exemplary method 700 may continue to the remaining steps shown in the exemplary method 700.

As shown in step 714, the exemplary method 700 may include determining a contact location on the virtual accessory and a contact time based on the accessory data and the projectile data. This may also or instead include determining a contact force based on the accessory data and the projectile data.

As shown in step 716, the exemplary method 700 may include, based on the contact scenario, selectively actuating one or more haptic feedback devices (e.g., solenoids) coupled to the accessory to provide haptic feedback to a user grasping, wearing, or wielding the accessory. This haptic feedback may substantially simulate contact between the accessory and a projectile. Selectively actuating one or more haptic feedback devices may further include defining a number of discrete contact scenarios characterizing contact between the virtual accessory and the virtual projectile within the virtual reality environment at a number of different locations on the virtual accessory and selectively actuating one or more haptic feedback devices according to one of the number of discrete contact scenarios most closely corresponding to a contact location estimated within the virtual reality environment. The contact scenario may also or instead include a characteristic pertaining to a level of force characterizing contact between the virtual accessory and the virtual projectile within the virtual reality environment, and the exemplary method 700 may also or instead include selectively actuating one or more haptic feedback devices according to this level of force.

As shown in step 718, the exemplary method 700 may include selecting audio feedback based on the contact scenario, determining timing for sending the audio feedback to a speaker to align with timing of the contact scenario, and transmitting the audio feedback to the speaker. In certain implementations, each simulated contact scenario has an accompanying audio feedback selection. For example, a virtual projectile hitting a certain part of the virtual accessory may be accompanied by a different sound than the virtual projectile hitting a different part of the virtual accessory. The speaker may include one or more of the audio devices 540 discussed herein (e.g., with reference to the helmet 500).

As discussed herein, the present teachings may utilize data from a live-action sequence. As further discussed herein, the live-action sequence may be occurring in near real time relative to operation of the virtual reality environment, or the live-action sequence may be a recording (e.g., of a completed sporting event or similar).

In the context of cricket, a common approach for batsmen in real-world environments is to practice against live bowling or to use a mechanical machine to practice form and timing. However, these real-world approaches may be limited by the fact that every bowler's delivery has its own subtle characteristics that are typically not replicated by conventional tools and methods. While some simulations (e.g., video games) may replicate a general delivery type as described above and may use a generic avatar to simulate a bowler, the computer-generated deliveries of these bowlers may vary significantly from actual real-world bowlers. Also, the release point of bowler avatars may become relatively easy for a batsman to predict, thus not being reflective of randomness of different bowlers' real-world release points. So, while a user may become proficient at hitting a cricket ball in a typical video game environment, such practice does not often translate into success in real-world situations because the timing and release point recognition may be vastly different. Another approach typically used includes reviewing film (e.g., reviewing still shots or video footage of a particular bowler). However, it may be difficult to capture still shots and video footage from a batsman's perspective, and, as a result, traditional still shots and video footage may fail to provide a batsman with the immersive experience of facing a real-world bowler. Implementations described herein may improve upon the aforementioned deficiencies by facilitating more immersive, realistic experiences for users.

For example, certain implementations discussed herein may facilitate a first-person perspective of cricket balls that incorporate the actual delivery and trajectory of balls from real-world bowlers. In some aspects, a user may watch a digitized avatar of a real-world bowler perform their own bowling sequence with a simulated cricket ball delivered from the bowler's tracked release point that leaves the bowler's hand. Depending on the ball, data may be used to simulate a flight path (and spin rate, spin direction, and so on, as applicable) associated with a bowled ball in the real-world.

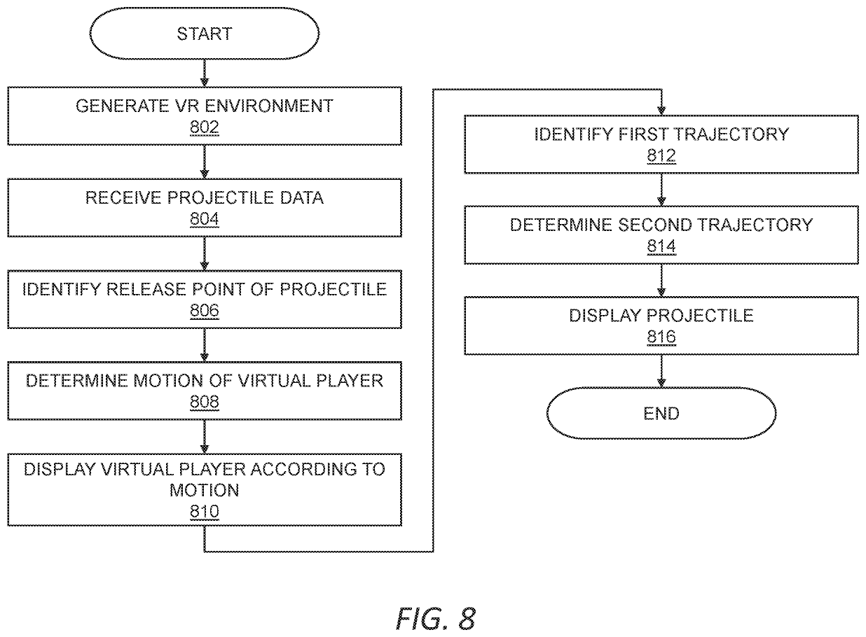

FIG. 8 is a flow chart of an exemplary method 800 of virtual reality simulation (e.g., using data from a live-action sequence). Unless otherwise specified or made clear from the context, it should be appreciated that the exemplary method 800 may be carried out using any one or more of the devices, systems, and methods described herein. In general, the exemplary method 800 may include using data from a live-action sequence to select an appropriate representation of a virtual player based on the data. For example, if the data includes information regarding a certain bowled ball in a live-action cricket match, simply placing that data directly into a virtual reality simulation may result in a mis-matched virtual bowler relative to a virtual representation of that bowled ball. Thus, a virtual bowler should have a release point that corresponds to the actual release point of the ball in the live-action cricket match. Also, or instead, a virtual bowler should have an appropriate motion corresponding to the ball in the live-action cricket match—e.g., a slower release for a relatively slow bowled ball.

The exemplary method 800 may also or instead include altering or adjusting data from a live-action sequence for incorporation into a virtual reality simulation. This may include, for example, adjusting a trajectory of a virtual ball relative to the ball in the live-action cricket match based on a difference in parameters between the virtual reality environment and the physical setting from the live-action cricket match—e.g., different weather or a different type of pitch. This may also or instead include, for example, adjusting a trajectory of a virtual ball relative to the ball in the live-action cricket match based on a difference in parameters or attributes between one or more virtual players in the virtual reality environment and one or more live-action players from the live-action cricket match. For example, if a virtual batsman is batting in a different alignment or is using a different batting stance (e.g., a right-handed or a left-handed stance) that differs from a batsman to which the ball in the live-action cricket match was bowled, this information may be used to adjust the trajectory of the virtual ball. This may be done in the same or similar manner in which a bowler in the physical world would adjust the bowled ball's trajectory based on the differing attribute. By way of further example, a virtual batsman may also or instead have a differing physical attribute relative to a batsman to which the ball in the live-action cricket match was bowled (e.g., is shorter or taller), and this information may be used to adjust the trajectory of the virtual ball. Altering or adjusting data from a live-action sequence for incorporation into a virtual reality simulation may also or instead include reformatting the data, filling in gaps in the data, and/or reverse-engineering or otherwise manipulating the data so that it can be effectively used in the virtual reality simulation.

As shown in step 802, the exemplary method 800 may include generating a virtual reality environment including a virtual player in a setting. As discussed herein, the virtual reality environment may be configured for use in a virtual reality cricket simulation, where a projectile includes a cricket ball and the virtual player is a bowler.

As shown in step 804, the exemplary method 800 may include receiving projectile data indicative of movement of a projectile launched by a player in a live-action sequence. As discussed herein, in the context of cricket, the projectile data may include information regarding a bowled ball from a live-action cricket match, and thus the player in the live-action sequence may include a bowler in the live-action cricket match. The projectile data may include one or more discrete locations of the projectile before, during, or after the release of the projectile launched by the player in the live-action sequence. The projectile data may also or instead include a trajectory of the projectile, a speed of the projectile (e.g., an initial velocity of the projectile when released by the player or a velocity recorded downstream from the player, where the velocity may be provided as vectors in three-dimensional space), a spin of the projectile (if any), a release point of the projectile, a release angle of the projectile, at least one location of the projectile downstream from the player (e.g., at a mid-point between its release and a target), a target location of the projectile downstream from the player (e.g., where it hits a target, or where it would have hit a target if not intervened with), and so on. Also, or instead, some of the aforementioned datapoints may be calculated or estimated from other information included in the projectile data. For example, a spin of the projectile, if present, may be estimated from a trajectory and a speed of the projectile, and/or from contact between the projectile and a playing surface (e.g., by analyzing the resulting directional vectors of the projectile before and after contacting the playing surface).

The projectile data may also or instead include information pertaining to the player that launched the projectile in the live-action sequence. For example, the projectile data may include the distance covered in a player's delivery when bowling a ball in cricket (e.g., the distance of the player's “run-up”), the speed of one or more portions of the delivery (e.g., the speed of the run-up, pre-delivery stride, ball release, or follow though), whether the player has a “side-on” or “front-on” action, and so on.

As shown in step 806, the exemplary method 800 may include, based on the projectile data, identifying a release point of the projectile by the player in the live-action sequence. The release point may be included in the projectile data, such that identifying the release point includes simply reading the projectile data. Also, or instead, identifying the release point may include calculating the release point based on information in the projectile data (e.g., based on a trajectory of the projectile).

As shown in step 808, the exemplary method 800 may include determining a motion of the virtual player in the virtual reality environment based on the projectile data and the release point. For example, if the projectile data shows a relatively slow bowled ball, the motion of the virtual player may be determined to be relatively slow, or have a relatively short run-up in their delivery.

Determining the motion of the virtual player may include selecting one of a plurality of motions stored in a database (e.g., the database 130 of FIG. 1). These motions may include motions of avatars or video feeds of live-action sequences as described below in step 810. The selected motion from the plurality of motions may be selected to most closely match attributes of the projectile data or the determined motion. In some implementations, the attributes of the projectile data are weighted. For example, while it may be true that a cricket bowler typically bowls a ball slower to achieve greater spin, the projectile data may show that a certain cricket bowler in a live-action sequence may have achieved both relatively high spin and a relatively high velocity. In such circumstances, the velocity attribute may be weighted higher than the spin attribute, so that a selected motion demonstrates that a ball will be released at a relatively high speed. Also, or instead, if the projectile data includes information pertaining to the player that launches the projectile, that information may be weighted more than information pertaining to the projectile itself. In this manner, if the player concealed the pace of the projectile or the spin of the projectile during their delivery, the player's concealment in their delivery may be substantially replicated in the virtual reality environment, thereby providing a more realistic experience to a user.

As shown in step 810, the exemplary method 800 may include, on a display of the virtual reality environment viewable by a user, displaying the virtual player moving according to the motion and a graphical representation of the projectile moving according to a temporal series of locations of the projectile. Displaying the virtual player moving according to the motion may include presenting a first-person view of the virtual player on the display as described herein. Displaying the virtual player moving according to the motion may also or instead include presenting video data of the player from a live-action sequence. In this manner, the virtual player may more directly correspond to the player that launched the projectile in a live-action sequence. Displaying the virtual player moving according to the motion may also or instead include presenting an avatar. The avatar may be based off of a player in the physical world, such as where the avatar is created using one or more of key-framing and motion capture techniques of the player in the physical world.

As shown in step 812, the exemplary method 800 may include, based on the projectile data, identifying a first trajectory of the projectile. The first trajectory may include the actual trajectory of the projectile in the real-world.

As shown in step 814, the exemplary method 800 may include manipulating the first trajectory using one or more parameters to determine a second trajectory. Manipulating the first trajectory may include adding a curvature to the first trajectory. The curvature may be based at least in part on a spin of the projectile (if any), or a reaction of the projectile when contacting a playing surface. Adding curvature to the first trajectory may be accomplished by introducing a constant bi-directional drag force (in the x- and z-directions) on the projectile. This constant force may be based at least in part on one or more of spin, seam angle, velocity in the direction opposite to the drag vector, air density, cross-sectional area of the projectile, and a drag force coefficient. Manipulating the first trajectory may also or instead include interpolating between different paths for the projectile created using one or more projectile motion equations. For example, manipulating the first trajectory may include cubic spline interpolation between three-dimensional data points to generate third-order polynomial equations that simulate the trajectory of the projectile in three-dimensional space.

Manipulating the first trajectory may also or instead include changing a parameter of the projectile data. By way of example, such a parameter may include one or more of a release point of the projectile, a release angle of the projectile, an initial speed of the projectile when released by the player, and a location of the projectile downstream from the player. For example, manipulating the first trajectory may include changing the release angle of the projectile or the rotation/swing of the player, which in turn can change the effect of a drag force on the projectile.

As discussed herein, the parameter may be changed based on a difference between the live-action sequence and the setting of the virtual reality environment. Thus, the exemplary method 800 may include altering a path of the graphical representation of the projectile in the virtual reality environment from a trajectory included in the projectile data based on one or more predetermined parameters that differ between the live-action sequence and the setting of the virtual reality environment. By way of example, such a difference between the live-action sequence and the setting of the virtual reality environment may include one or more of a playing surface, weather, lighting, time of day or time of year, climate or altitude (e.g., for air density), a physical attribute of a user (e.g., a height of the user for displaying the user as a batsman in a virtual reality cricket simulation, whether the user is right-handed or left-handed, and so on), and a physical attribute of a virtual player (e.g., the height of a bowler in a virtual reality cricket simulation, whether the bowler is right-handed or left-handed, and so on).

As shown in step 816, the exemplary method 800 may include, on a display of the virtual reality environment viewable by a user, displaying a graphical representation of the projectile launched from the virtual player and moving according to the second trajectory.

Thus, using techniques described above, data from a live cricket match with recorded ball data (e.g., trajectory and location data) may be used in a virtual reality environment (e.g., in substantially real time). The virtual reality environment may substantially mimic the real-world setting from the live cricket match, or a different setting, where the user, as the batman, may see virtual representations from a first-person perspective including representations of themselves (e.g., their hands or gloves, their bat, a part of their helmet, and so on). In this manner, the user may view a virtual reality version of a real-world cricket ball that is bowled in the same or similar manner in a live-action cricket match. Furthermore, virtual reality simulation techniques disclosed herein may facilitate the user viewing a playback of recorded data from a live-action sequence. Thus, in implementations, a virtual reality simulation method facilitates game play with professional athletes.

As described above, for a more immersive experience, movements of a bowler from a live-action sequence such as a live cricket match may be recorded and automatically applied to a player within the virtual reality simulation. The player may thus make the same approach as a professional bowler in a live-action match, and may release a ball in the virtual reality simulation that follows the same (or similar) path as the ball in the live-action match. This may facilitate asynchronous play between fans at home and professionals around the world.

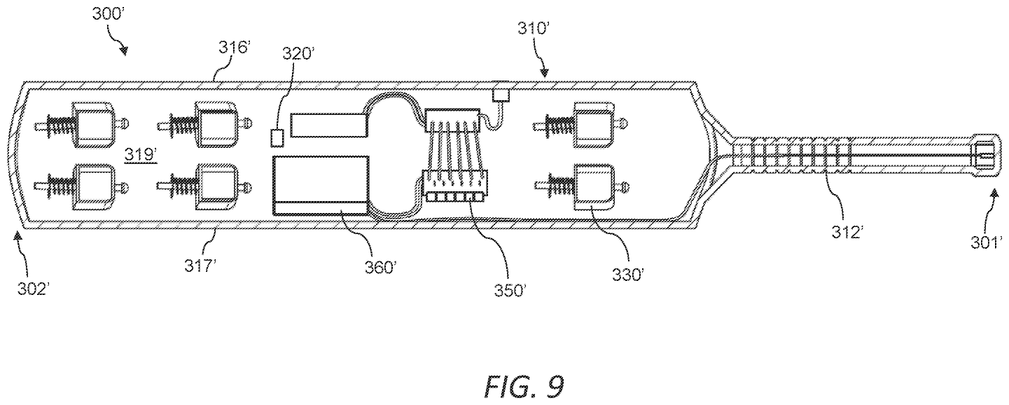

While certain implementations have been described, other implementations are additionally or alternatively possible. For example, while a certain configuration of an accessory including a bat 300 is described above with reference to FIGS. 3A and 3B, other accessory configurations are additionally or alternatively possible for the bat. For example, referring now to FIG. 9, a bat 300′ may include an alternate arrangement and orientation for the solenoids 330′ disposed therein. For the sake of efficient description, elements with prime (') element numbers in FIG. 9 should be understood to be similar to elements with unprimed element numbers in FIGS. 3A and 3B, and are not described separately herein.

In another alternate implementation, one or more haptic feedback devices or solenoids are disposed on an exterior of an accessory. In this manner, the haptic feedback devices may be structurally configured to strike or otherwise contact an exterior surface of the accessory to provide force feedback (e.g., for replicating a projectile or other object striking the surface of the accessory).

Further, it will be understood that any of the devices, systems, and methods described herein may also or instead include other hardware such as a camera or other sensors, power sources, controls, input devices such as a keyboard, a touchpad, a computer mouse, a switch, a dial, a button, and so on, and output devices such as a display, a speaker or other audio transducer, light-emitting diodes or other lighting or display components, and the like. Other hardware may also or instead include a variety of cable connections and/or hardware adapters for connecting to, for example, external computers, external hardware, external instrumentation or data acquisition systems, and the like.

Moreover, it will be understood that any of the devices, systems, and methods described herein may also or instead include other aspects of virtual reality simulation such as those found in typical virtual reality gaming. By way of example, a virtual reality simulation described herein may score a user's performance and decisions. In the context of cricket, these scores may be based on whether to bat, the quality of the batting, and other game-related factors. In one or more embodiments, a user may repeat a sequence of virtual play or may move on to additional plays. A user's progress (or regression) over time may be tracked and monitored. The user may also or instead be able to access scores, replay scenes, as well as view and review data, for example, via a personalized summary on a webpage, mobile application, or gaming interface.

IV. Use of Projectile Data

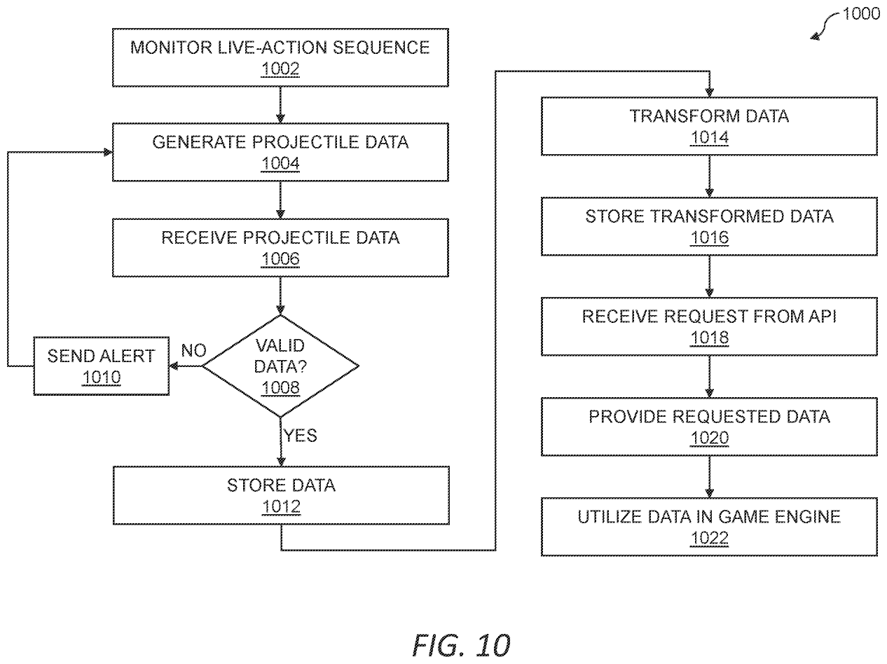

As discussed herein, implementations may include representing a live-action sequence and (wholly or partially) recreating that sequence, as accurately as possible, within a virtual reality environment for use in a virtual reality game or similar. Specifically, certain implementations include the use of projectile data from a live-action sporting event in a virtual reality setting, e.g., where the projectile data is characterizing the path of a cricket ball bowled by a player (e.g., the “bowler”) in a live-action cricket match. Other implementations may include the use of projectile data characterizing the path of a baseball or softball released by a player (e.g., the “pitcher”) in a live-action baseball game or a live-action softball game. It will be understood, however, that the techniques described herein may be used for a number of various live-action sequences (e.g., sports and games) where a player strikes a moving ball or other projectile, and thus the present disclosure generally describes the use of projectile data characterizing a trajectory of a projectile launched (e.g., by a player) in a live-action sequence (e.g., a sporting match). An example of a pipeline for the use of such projectile data is set forth below with reference to FIG. 10.

FIG. 10 is a flow chart of an exemplary method for using projectile data.

As shown in step 1002, the method 1000 may include monitoring a live-action sequence, such as any of those described herein (e.g., a sporting event such as a cricket match). Monitoring the live-action sequence may include acquiring data and related information for generating projectile data as described herein. Such data acquisition may include the use of one or more of a camera, a sensor, an optical device, and so on. For example, a plurality of cameras may be situated around an area of interest, where the cameras are in communication with one or more computing devices. In this manner, a computing device can process image data from the cameras to estimate or otherwise measure a path of a projectile such as a cricket ball, e.g., based on independent estimates using the video stream from each camera, or by combining multiple views into a single three-dimensional representation of the path of a projectile. Similarly, other range-finding and/or speed measurement devices such as radar, lidar, laser, or any other acoustic, optical, video, or other techniques, and combinations of the foregoing, may be used to track the path of a projectile when monitoring a live-action sequence to generate projectile data.

As shown in step 1004, the method 1000 may include generating projectile data from information obtained when monitoring the live-action sequence. The projectile data may be transmitted (e.g., automatically upon its generation) to a database hosted on a server, which may in turn provide an application programming interface (API) for remote access to the projectile data. The projectile data may otherwise be stored on a database (e.g., local and/or remote) accessible to one or more authorized users for retrieving such data.

The projectile data may include descriptive data such as a team associated with a projectile (e.g., a team that includes the player that launched the projectile and/or a team that opposes said player), a player associated with a projectile (e.g., the player that launched the projectile and/or a player that is attempting to interact with the projectile such as a batsman in a cricket match) and/or an attribute of such a player (e.g., handedness, physical characteristics, tendencies, demographics, and so on), a time and/or date (e.g., of a live-action event, generally and/or for specific projectiles), a name or other identifying information for a live-action event (e.g., a sporting match), a geographic location, a weather condition, an attribute of a playing surface (e.g., type, condition, a coefficient of friction, a coefficient of restitution, and so on), combinations thereof, and the like. The data may also or instead include physically descriptive data about a particular projectile such as a release angle of the projectile, a velocity of the projectile (e.g., an initial velocity and/or a velocity at one or more downstream locations after release), coordinates for the projectile (before, during, or after release, or any combination of these—e.g., at the release point and a location where the projectile crosses a certain threshold downstream from its release such as the crease in a cricket match), spin of the projectile, a bounce and/or contact location for the projectile with another object (e.g., the playing surface, a bat, a player, a wicket, and so on), combinations thereof, and the like. The data may also or instead include other contextual information for a game around the time the projectile is launched, such as positions of persons associated with the projectile (e.g., fielders in a cricket match), a reaction time for engaging with the projectile at a certain location downstream from its release, a time of travel between at least two predetermined locations, delivery type for a projectile (e.g., spin, fast, swing, etc.), an order or sequence identifier for a projectile (e.g., pitch count, inning information, number of bowled balls, etc.), combinations thereof, and the like. More generally, this may include any data measured, estimated, and/or calculated data for the projectile, as well as any other contextual information characterizing the environment in which the projectile was launched including, e.g., game data, match data, team data, player data, geographic data, weather data, combinations thereof, and the like.

As shown in step 1006, the method 1000 may include receiving the projectile data. As discussed above, the projectile data may be received and stored in a database accessible through an API or the like. In this manner, the API may provide access to the projectile data, e.g., for human or programmatic users. The projectile data may be in JavaScript Object Notation (JSON) format or the like, or the projectile data may be converted to JSON or similar. Other formats for the projectile data are also or instead possible.

Receiving the projectile data may also or instead include an upload of data by a third-party that monitors the live-action sequence and generates the projectile data. For example, a server or database hosted by a server may receive the projectile data (e.g., in JSON format) when it is uploaded through a data network from a third-party. The projectile data may be uploaded in bulk and/or on a per projectile basis, e.g., as a live-action sequence is occurring in real time. Similarly, the projectile data may be received in a native format in which the projectile data is stored, or the projectile data may be converted from a third-party format prior to storage in the database. Thus, in certain implementations, a technique for virtual reality simulation of a projectile may include receiving projectile data in an unstructured format, where this projectile data may characterize a trajectory of a number of projectiles launched by a player in a live-action sequence.

As shown in step 1008, the method 1000 may include analyzing the validity of the projectile data. Analyzing the validity of the projectile data may include verifying whether the projectile data includes useful, accurate, and/or properly formatted information, e.g., information needed to use the projectile data in a virtual reality setting. This may, for example, include filtering of erroneous or superfluous data. If the projectile data is invalid, an alert may be transmitted as shown in step 1010. Such an alert may include information regarding a reason the projectile data was deemed to be invalid. The alert may be sent to a user that generated the data and/or a user that uses such projectile data. Upon receiving such an alert, the projectile data may be reconfigured or discarded for new projectile data that is generated in step 1004.

As discussed above, analyzing the validity of the projectile data may include verifying that certain information is included within the projectile data. For example, this may include verifying that the data includes sufficient physical data to render the projectile in a virtual gaming environment, and/or that the data includes sufficient identifying information to ensure that the projectile is properly associated with a particular game or sequence. Some examples of data that may be desirous for use in a virtual reality game may include a match date, a match name, a delivery number, a delivery type, a handedness of a player (e.g., a bowler and/or batsman), a release speed, a release position, a bounce position, a crease position (e.g., at the batting end), combinations thereof, and the like. Some other examples of data that may be helpful include a pre-bounce velocity, a post bounce velocity, a drop angle (e.g., from a bowler's wrist), a bounce angle, a deviation off of the playing surface, a swing, a spin rate, combinations thereof, and the like. Other information is also or instead possible.

As shown in step 1012, the method 1000 may include storing the projectile data, e.g., in a database (or a plurality of databases) that can be accessed through an API for retrieval of the projectile data.

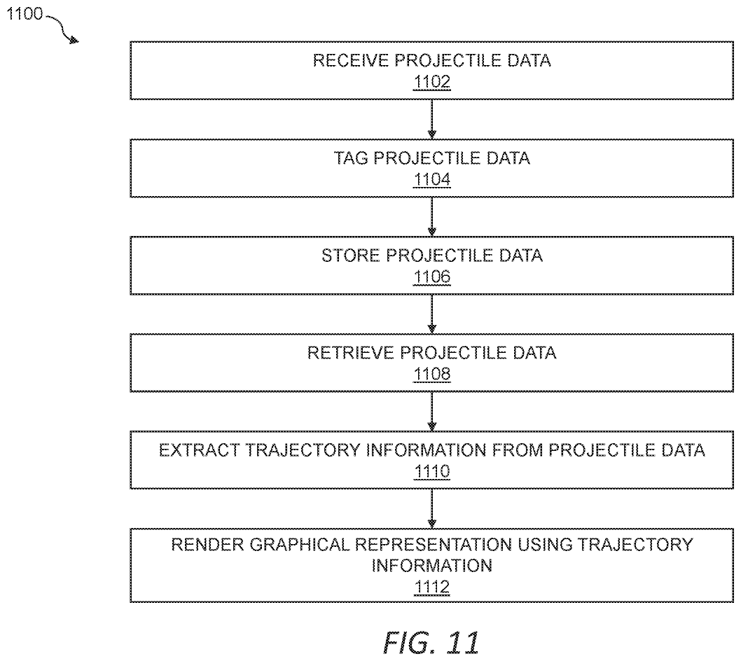

As shown in step 1014, the method 1000 may include transforming the projectile data. Transformation of the projectile data may include adding one or more tags to the projectile data, such as a tag associated with a date, a time, an event, combinations thereof, and the like. Transformation of the projectile data may also or instead include adding one or more data fields to the data. Transformation of the projectile data may also or instead include extracting useful information from the projectile data. Further information regarding the transformation of projectile data is discussed below, e.g., with reference to FIG. 11.

As shown in step 1016, the method 1000 may include storing the transformed projectile data, e.g., in one or more databases. For example, the transformed projectile data may be stored in a first database accessible with an API or the like for use in a virtual reality game and a second database where it can be used for generating comprehensive, historical data and/or the like. One or more of the databases that stores the transformed projectile data may be linked to a server that can facilitate transfer of the data to a gaming engine or the like. For example, in certain implementations, an API may be provided for data transfer between a server hosting a historical data store and a gaming engine, or an API may be provided to support live game projectile data or the like. Thus, in certain implementations, a second database may accumulate received projectile data from a live-action event for persistent storage and an API can be used to fetch a number of historic projectiles—e.g., from the beginning of the live-action event to the time a virtual reality simulation was switched-on for use or when there is a momentary connection loss during use. This may ensure that all of the projectiles from the live-action event are available to play in a virtual reality simulation relatively seamlessly and at any point during use or in the future.

As shown in step 1018, the method 1000 may include receiving a request from an API for projectile data, e.g., the transformed projectile data. As discussed herein, the API may be associated with a virtual reality gaming engine or the like. For example, based on the configuration, a virtual reality game may subscribe to a port on a server such that, whenever new projectile data is uploaded from a predetermined live-action sequence (e.g., a cricket match that a gaming engine or a user thereof is subscribed to, i.e., for receiving balls bowled by a player in near real-time) on the server, the server triggers or generates an event updating the virtual reality game regarding new projectile data. In this manner, if the virtual reality game is already subscribed to the event, the game can receive the updated data automatically. Also, or instead, based on the configuration, a virtual reality game may query the server to see if there is any new projectile data available, and, if there is new projectile data available, the virtual reality game may fetch the new data.

As shown in step 1020, the method 1000 may include providing the requested projectile data. This may be in response to authenticating a requestor, or otherwise providing access to projectile data.

As shown in step 1022, the method 1000 may include using the projectile data in a virtual reality game, e.g., by rendering or otherwise processing the projectile data with a gaming engine or the like. This may include a rendered recreation of the live-action sequence from which the projectile data is derived in substantially the same form. This may also or instead include a manipulation of the projectile data to change the live-action sequence in a predetermined manner—e.g., mirroring the trajectory of the projectile to switch the release point of the projectile to account for a different handedness of a player that launched the projectile. By way of example, in a cricket simulation, mirroring the ball data may provide a left-handed and right-handed batsman with a relatively similar experience based off of the same projectile data. That is, if a ball was bowled to a right-handed batsman, its release position, bowling arm, bounce position, and crease position may be mirrored to provide the same experience to a left-handed batsman (and vice-versa). Other manipulations of the projectile data are also or instead possible.

The transformation of projectile data for use in a virtual reality environment will now be described. FIG. 11 is a flow chart of an exemplary method for using projectile data. As discussed herein, the projectile data, in its raw form or in a format received from a third-party, may be transformed for use in a virtual reality environment. Thus, implementations may include a method 1100 for virtual reality simulation of a projectile that includes such a transformation of projectile data.

As shown in step 1102, the method 1100 may include receiving projectile data, where such projectile data may be received in an unstructured format. The projectile data may characterize a trajectory of a number of projectiles launched by a player in a live-action sequence—e.g., cricket balls bowled by a player in a live-action cricket match. The projectile data may be the same or similar to the projectile data discussed elsewhere herein.

As shown in step 1104, the method 1100 may include tagging the projectile data—e.g., with a date and a time for each of the number of projectiles—thereby providing tagged projectile data. The date and the time may be associated with the live-action sequence from which the projectile data was derived. In this manner, projectiles associated with certain live-action sequences (e.g., particular cricket matches or tournaments) can be grouped together, e.g., for transmission or retrieval in a particular sequence (such as the same sequence that certain cricket balls were bowled in a particular cricket match). Thus, one or more tags added to the projectile data may be used for organizing or filtering particular data.

In certain implementations, the unstructured projectile data includes a date and/or a time, but this information is not exposed in a usable field—e.g., this information may be included in metadata or the like. Thus, the method 1100 may include exposing this information in a predetermined manner for use in the systems and methods described herein. In certain implementations, information contained in metadata is exposed as a variable through the tagging process. Moreover, a match date may be an exposed variable via a regular expression command to organize received projectile data by match date. An example of code for such a process is presented below:

deliveryDate=req.body.match.delivery.trajectory.trajectoryData.match(/(\d{1,4}([.\-/])\d{1,2}([.\-/])\d{1,4})/g)

As shown in step 1106, the method 1100 may include storing the tagged projectile data in a data structure configured to facilitate programmatic retrieval of the projectile data on a per-projectile basis. In one aspect, projectile data may be received from a variety of different sources, such as different third-party data providers. In this case, the projectile data may be correlated using time stamp data or the like to facilitate storage of multi-source data in a single data structure for retrieval and use in game play. Furthermore, the data received may not necessarily be derived from a desired live-action event or sequence (e.g., cricket matches), as there may be multiple such live events occurring on the same date or at the same time. In these instances, the projectile data may be correlated—e.g., using match date, match name, and innings data—to facilitate storage of multi-source data in a single ordered data structure representing each live-action event, e.g., ordered by match date, match name, and innings for retrieval and use in a virtual reality simulation.

As shown in step 1108, the method 1100 may include, based on an instruction received from an application programming interface (API), retrieving projectile data for a selected projectile of the number of projectiles based on a requested date and a requested time. For example, as described herein, an API may be programmed to retrieve all projectile data pertaining to a certain live-action sequence (e.g., a significant live-action cricket match occurring in near real-time, or an event that has previously occurred—such as a championship match, an iconic performance (e.g., a perfect game thrown in baseball), or the like).

As shown in step 1110, the method 1100 may include extracting trajectory information from the projectile data for the selected projectile. The trajectory information may include one or more of: (i) a first position of the selected projectile corresponding to a location where the selected projectile is launched by the player; (ii) an initial velocity of the selected projectile when the selected projectile is launched by the player; (iii) a downstream position of the selected projectile at a predetermined position disposed away from the player; and/or, (iv) when the selected projectile contacts a playing surface in the live-action sequence, a bounce position where such contact occurs.

As shown in step 1112, the method 1100 may include rendering a graphical representation of the trajectory with a virtual projectile in a display of a virtual reality environment using the trajectory information. As discussed herein, the virtual reality environment may be configured for use in a virtual reality cricket simulation, game, or training session, where the projectile is a cricket ball and the player in the live-action sequence is a bowler in a cricket match. Also or instead, the virtual reality environment may be configured for use in a virtual reality baseball simulation, game, or training session, where the projectile is a baseball and the player in the live action sequence is a pitcher in a baseball game.

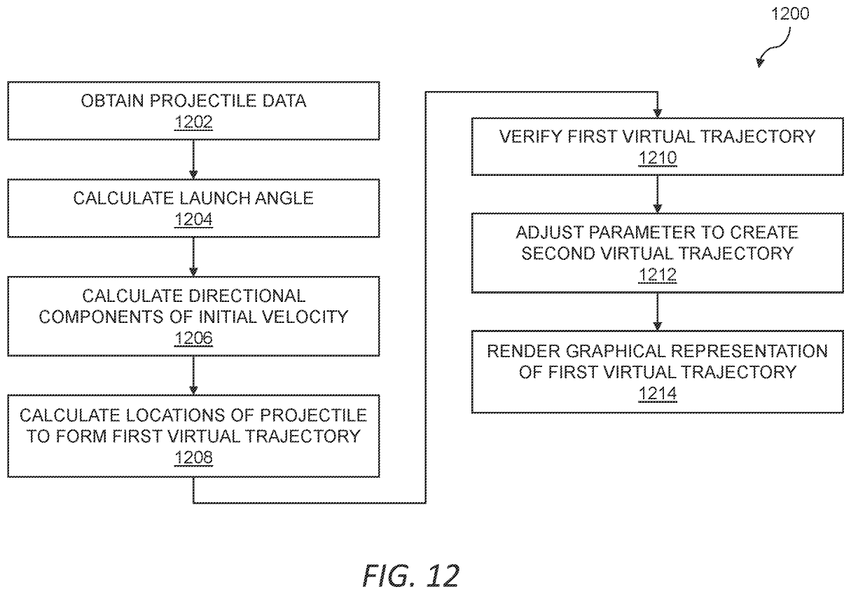

Techniques for creating realistic projectile movement in a virtual reality setting will now be described. FIG. 12 is a flow chart of an exemplary method for using projectile data. As discussed herein, the projectile data from a live-action sequence may be used to recreate motion of the projectile within a virtual reality environment in a relatively realistic manner, e.g., where the projectile moves in the same or a similar manner in the virtual reality environment as it did in the live-action sequence. Thus, implementations may include a method 1200 for virtual reality simulation of a projectile that aims to create realistic projectile movement that mimics projectile movement from a live-action sequence.

As shown in step 1202, the method 1200 may include obtaining projectile data characterizing a trajectory of a projectile launched by a player in a live-action sequence—e.g., a cricket ball bowled by a player in a live-action cricket match, a baseball pitched by a pitcher in a live-action baseball game, and so on. The projectile data may include one or more of: (i) a first position of the projectile corresponding to a location where the projectile is launched by the player (e.g., a three-dimensional location in any suitable coordinate system); (ii) an initial velocity of the projectile when the projectile is launched by the player; and/or (iii) a second position of the projectile along the trajectory at a second position time, where the second position is disposed downstream from the first position along the trajectory. It will be understood that, while the launch angle may not be known, e.g., it may not be provided among the initial constraints or data for the projectile, the velocity will typically be a vector and/or include a direction in which the velocity is measured. This vector or the like may be directed, for example, toward a particular point, parallel to the playing field surface (e.g., with no z-axis component) and toward a point, or in any other direction that may be decomposed into x, y, and z axis components, or otherwise directionally characterized within the virtual environment. In certain implementations, the second position is a bounce position of the projectile first contacting a playing surface after being launched by the player. Thus, the first virtual trajectory—as a whole, or at least in part—may be disposed between the first position and the bounce position. In other implementations, the second position is another predetermined position such as a crease position, a wicket position, a batsman's position, a position relative to another structure such as a home plate, and so on.

As shown in step 1204, the method 1200 may include calculating a launch angle for the projectile at, or immediately downstream of, the first position based on the projectile data. For example, based on the known constraints—an initial known position and velocity, and a position at a subsequent, known point in time—an initial launch angle may be determined that couples the initial and final conditions. The launch angle or angle of incidence of the projectile may be calculated based on a bounce position or other known downstream position from launch, which can be adjusted to account for air resistance or drag, and used along with other initial constraints such as the release position and velocity to simulate the projectile travel and determine a launch angle that reaches the bounce position or other known downstream position at a known time (or a known elapsed time from the time of the release position).

As shown in step 1206, the method 1200 may include calculating one or more directional components of the initial velocity of the projectile. For example, this may include decomposing the launch angle into any suitable vector components, or otherwise determining additional initial conditions useful for rendering a path of the projectile. This process may reconcile the measured velocity at release with the calculated launch angle to facilitate a recreation of a complete, estimated flight path suitable for reproduction within a virtual environment. As a significant advantage, this approach may permit recreation of the flight path based upon a relatively small set of boundary conditions, using information (such as initial velocity toward a target) that can be readily captured for live games using a variety of well-known sensors and techniques, and/or acquired from third-party commercial services that measure and provide same. When the amount of swing (e.g., curvature of the projectile during its flight path) is known, the three components of the velocity may be determined based on a calculated incident angle needed to reach a target position (e.g., bounce position), where x can be the component for a lateral direction (e.g., swing due to ball spin, wind, or other conditions), y can be the component for a downward direction (e.g., as influenced by gravity during flight), and z can be the component for a forward direction (e.g., as influenced by drag). When swing is not known, the projectile may be rotated on its local y axis so that the forward (z) vector faces the target position and the same or similar steps may be followed to calculate the incident angle as well as the y and z velocity vectors, respectively.

It will be appreciated that, while the calculation of launch angle and the calculation of directional components of initial velocity are described separately, these values may be concurrently determined in any calculation or process that applies that initial conditions (e.g., known initial position, known subsequent position, and known initial velocity in a predetermined direction) to provide directional components of the initial release or otherwise disambiguates the vector components of the initial release.

As shown in step 1208, the method 1200 may include calculating a number of locations of the projectile along the trajectory based on the projectile data, the launch angle, a mass of the projectile (e.g., an estimated or known mass), and application of a predetermined drag coefficient to the projectile, where the number of locations form points along a first virtual trajectory. The method 1200 may further include calculating a directional vector of the projectile at one or more of the number of locations.

The predetermined drag coefficient may correspond to quadratic drag applied to the projectile, e.g., using a drag that is proportional to a square of the velocity of the projectile. While this may require use of numerical techniques when calculating a projectile trajectory, the resulting path may more closely reproduce projectile flight, providing significant benefits when rendering the three-dimensional trajectory for a human viewer. The predetermined drag may be related to the velocity of the projectile at a particular instant as well as the mass of the projectile. In general, the predetermined drag may be a force applied in the opposite direction of the path of travel for the projectile. In one empirical embodiment, a coefficient of drag of about 0.002 achieved drag force generally consistent with actual flight behavior and suitable for rendering projectile movement in a virtual environment. Other values for the coefficient of drag are also or instead possible. The predetermined drag may also or instead be applied at every frame of a graphical representation of the first virtual trajectory.

As shown in step 1210, the method 1200 may include verifying the first virtual trajectory, e.g., based on the second position and the second position time. This may generally be used to ensure that the incremental calculations of trajectory achieve a correct result at a second, known location measured for the projectile in data captured from the live event. In one aspect, this may be applied to individual game balls in order to ensure continued accuracy of the rendered, virtual counterparts and to dynamically adjust any corresponding calculations (e.g., by altering drag coefficients, displacement or angle of repose during a bounce, and so forth). In another aspect, these calculations may be used to tune calculations and corresponding parameters in a debugging phase, so that tuned values can be used during live game play.

Other corrections and adjustments may also or instead be made. For example, there may be one or more colliders (e.g., represented by bounded boxes or other suitable constructs within a physics engine or other representation of the virtual environment) representing solid objects within the virtual environment that might intersect with the trajectory of the projectile. This may for example include wickets, a bat, a playing surface, a player, and any other physical bodies that might impede the trajectory of a projectile. If one or more of these colliders are not accounted for, the first virtual trajectory may be known to include errors.

Also, or instead, if the projectile bounces, its velocity and firing angle may be calculated post-bounce (e.g., using the techniques herein, or any other suitable techniques). In this manner, this technique can ensure that the trajectory of the projectile is the same post-bounce using the second position. The position of the projectile may also be adjusted at the moment of bounce. For example, by making a slight forward (toward a batter) adjustment in position at the time of a bounce (e.g., one or two centimeters forward), a highly accurate reproduction of the bounce event can advantageously be recreated without requiring complex surface collision calculations.

Thus, in certain implementations, the trajectory is broken down into at least two parts: pre-bounce and post-bounce. In the first, pre-bounce part, the launch angle (incident angle) may be calculated based on a target position (e.g., bounce position) with its velocity components. In the second, post-bounce part, a pre-calculated post-bounce velocity and bounce angle (reflected angle) may be applied in the frame where the projectile reaches the end of the first part or in the frame where the projectile reaches the target position and as a result hits a collider to register a collision. In this collision frame, a predetermined velocity and bounce angle may be applied to the projectile, which can propel the projectile to reach a precise post-bounce destination such as the specific crease position (e.g., at the batsman's end).

As shown in step 1212, the method 1200 may include adjusting a parameter to create a second virtual trajectory, e.g., to correct any deficiencies in the first virtual trajectory. For example, the method 1200 may include adjusting the predetermined drag coefficient according to a deviation between a position along the first virtual trajectory and the second position at the second position time thereby creating a second virtual trajectory. The method 1200 may also or instead include comparing a reaction time (e.g., the time a batsman would have to react to a bowler launching a cricket ball, which may be related to the time from the release of the cricket ball to the time when the ball crosses the crease on a playing field) within the graphical representation to an actual reaction time in the live-action sequence, and adjusting the first virtual trajectory based on a difference therebetween. In this manner, the simulation can be more closely tied to the physical experience of a batsman during live game play.

In certain implementations, the method 1200 may also or instead include adjusting the drag applied to the projectile according to a deviation between the first virtual trajectory and the second position at the second position time. The resulting trajectory from this adjustment may be the second virtual trajectory discussed above. As noted above, this may be performed during a debugging or calibration stage prior to processing game balls for a user, or this may be performed dynamically during a user simulation in order to ensure that rendered events remain closely correlated to the corresponding physical events.

As shown in step 1214, the method 1200 may include rendering a graphical representation of the first virtual trajectory with a virtual projectile in a display of a virtual reality environment. As discussed herein, the virtual reality environment may be configured for use in a virtual reality cricket simulation, where the projectile is a cricket ball and the player in the live-action sequence is a bowler in a cricket match. And, as further discussed herein, the virtual reality environment may be configured for use in a virtual reality baseball simulation, where the projectile is a baseball and the player in the live-action sequence is a batter in a baseball game.

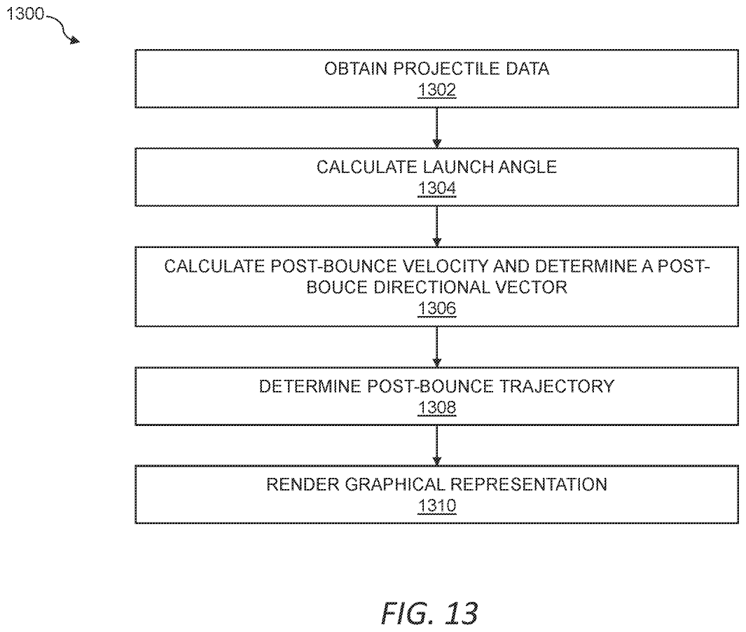

Techniques for determining and recreating post-bounce behavior of a projectile for virtual reality representation will now be described. FIG. 13 is a flow chart of an exemplary method for using projectile data. As discussed herein, the present teachings may include recreating a live-action sequence in a virtual reality environment, such as the recreation of a live-action cricket match (or a portion thereof) in a virtual reality cricket simulation, game, and/or training system, or the recreation of a live-action baseball game (or a portion thereof) in a virtual reality baseball simulation, game, and/or training system. Using this technique, a player of a virtual reality cricket game can experience a similar feeling to a real world batsman in the live-action cricket match through the recreation of certain bowled balls; and/or a player of a virtual reality baseball game can experience a similar feeling to a real world batter in the live-action baseball game through the recreation of certain pitches of baseballs.

As further discussed herein, many bowled balls in a cricket match bounce off of the playing surface between the bowler and the batsman. Reproducing the entire flight of such a bowled ball may include recreation of a first trajectory between a release position and a bounce position, as well as recreation of a second trajectory between the bounce position and the batsman (or another location downstream from the bounce position). In this manner, the present teachings include techniques for recreating post-bounce behavior of a projectile in a virtual reality environment. It will be understood, however, that the recreation of a live-action cricket sequence is just an example of a use-case that can benefit from the present teachings, and other implementations are also or instead possible.

As shown in step 1302, the method 1300 may include obtaining projectile data characterizing a trajectory of a projectile launched by a player in a live-action sequence—e.g., a cricket ball bowled by a player in a live-action cricket match. The projectile data may include one or more of: (i) a first position of the projectile corresponding to a location where the projectile is launched by the player; (ii) an initial velocity of the projectile when the projectile is launched by the player; (iii) a bounce position where the projectile contacts a playing surface or is projected to contact the playing surface after being launched by the player; and/or (iv) a known downstream position of the projectile at a predetermined location downstream from the bounce position.

As shown in step 1304, the method 1300 may include calculating a launch angle for the projectile at, or immediately downstream of, the first position based on the projectile data. The launch angle may be calculated using the same or similar techniques described above with reference to FIG. 12.

As shown in step 1306, the method 1300 may include calculating a post-bounce velocity and determining a post-bounce directional vector at a location immediately downstream from the bounce position using one or more of: (i) a predetermined coefficient of restitution between the playing surface and the projectile; and/or (ii) the known downstream position. In this context, the predetermined coefficient of restitution may characterize a manner in which the projectile responds to contact with the playing surface.

By way of example, the post-bounce velocity may be calculated using a predetermined decrease in velocity from a pre-bounce velocity, where the pre-bounce velocity is derived from the initial velocity, e.g., using known projectile motion equations. This predetermined decrease in velocity may be between about 10% and about 15% from the pre-bounce velocity. In one aspect, the decrease may vary as a function of other conditions. By way of example, a first decrease in velocity (e.g., a decrease of about 10% from a pre-bounce velocity) may be applied to projectiles that have a pre-bounce velocity above a predetermined threshold, and a second decrease in velocity that is greater than the first decrease in velocity (e.g., a decrease of about 15% from a pre-bounce velocity) may be applied to projectiles that have a pre-bounce velocity below the predetermined threshold.

The predetermined decrease in velocity may also or instead be based at least in part on an attribute of the playing surface, e.g., where this attribute is identified in the projectile data. For example, certain “faster” playing surfaces are known to allow for a bouncing projectile to maintain most of its velocity after it bounces, while other “slower” playing surfaces are known to decrease the velocity of a projectile after it bounces more than the aforementioned “faster” playing surfaces. Thus, the attribute of the playing surface may include at least one of a composition of the playing surface (e.g., whether the playing surface is dirt and/or grass, as well as a type of dirt and/or grass of the playing surface, and the like), a geographic location of the playing surface, a wetness of the playing surface, and an environmental condition that can affect the playing surface (e.g., a humidity, a temperature, cloudiness or sun, rain or shine, and the like). A condition of the playing surface may also or instead be taken into account when determining or selecting the predetermined decrease in velocity, such as whether a playing surface is relatively wet or relatively dry. The condition of the playing surface may also be inferred from conditions such current weather (e.g., rainfall, temperature), historical weather (e.g., temperature or rainfall history for a preceding number of days), time of year, and so forth. The predetermined decrease in velocity may also or instead be based at least in part on an attribute of the player that launched the projectile, such as whether the player tends to add a relatively large amount of spin to the projectile when launching the projectile. Other factors for determining or selecting the predetermined decrease in velocity are also or instead possible.

At the same time that the velocity is decreased, a ball may be physically displaced along the playing surface. This may be a fixed displacement, e.g., 1 or 2 centimeters toward the batsman, or the ball may be displaced toward the batsman by a distance that is a function of the velocity at contact, or using some other formula. This may also or instead depend on the variables discussed above such as characteristics of the playing surface, weather conditions, bowling or pitching style, and so forth. In general, the use of a simplified spatial displacement at the moment and location of ball contact can advantageously provide a substantial computational simplification that nonetheless faithfully reproduces the visual effect of contact with the playing surface as perceived by a batsman within the virtual reality environment.

As shown in step 1308, the method 1300 may include determining a post-bounce trajectory disposed between the bounce position and a known downstream position—e.g., using the post-bounce velocity, the post-bounce directional vector, and/or the known downstream position. For example, the direction and velocity may be changed according to the known downstream position, where these values can be pre-calculated. And, in some implementations, the simulation does not stop, such that the resetting of direction and velocity occurs within one physics frame (e.g., when a collision is first detected with the launch of the projectile, a function “OnCollisionEnter” may be triggered, which is usually called when the projectile is just beginning to collide with, or is within millimeters from, the playing surface). The simulation may run at about 500 frames per second or about 2 milliseconds per frame, so this resetting may occur within a single 2 millisecond frame in some implementations.

As shown in step 1310, the method 1300 may include rendering a graphical representation of the trajectory, including the post-bounce trajectory, using a virtual projectile in a display of a virtual reality environment. As discussed herein, the virtual reality environment may be configured for use in a virtual reality cricket simulation, where the virtual projectile is a cricket ball and the player in the live-action sequence is a bowler in a cricket match. In one aspect, the virtual projectile and the player may be simulations of a live cricket match.

Ball Projectile Physics Example

As explained herein, to simulate a trajectory of a real-world projectile in a virtual reality environment, Newtonian projectile motion equations may be used. That is, typically, the projectile is launched in the direction of the destination (e.g., a bounce position) from the player's hand with a velocity and an angle that are known, and/or that can be calculated using projectile motion equations. From the moment of release, a physics engine may be used to calculate certain information at every frame of a graphical representation within a virtual reality environment. For example, the physics engine may run at about 500 frames per second, whereas the physical display may be rendered at about 90 frames per second (a speed that allows for an accurate recreation of the projectile in the display).

An example of using projectile data related to a ball bowled in a cricket match is explained below. In this example, sections of computer code or pseudo-code are presented in italics, with comments preceded by “//.”.

```
// distance between target and source
  float dist = Vector3.Distance(pos, target);
// rotate the object to face the target
  transform.LookAt(target);
float Vi = 0f;
```

In the computer code included above, the target is where the cricket ball bounces or a predetermined location where the trajectory would lead the ball from where the ball is released by the bowler. Thus, the target may include the first position that a cricket ball strikes another object (e.g., the playing surface, a wicket, and so on) after being released by the bowler.

In the computer code included above, Vi is the initial velocity of the cricket ball when it is released by the bowler. This may be a velocity toward the target, or a velocity along any other known axis within the virtual environment. The target and the initial velocity may be provided within projectile data received by a third-party service or the like.

This code section may assist in determining the forward vector of the cricket ball, e.g., by aligning the vector with the target.

```
    if (throwTarget.Equals(ThrowTarget.Wickets) ||
throwTarget.Equals(ThrowTarget.WicketKeeper))
    {
      float distRatio = dist / 110f;
      Vi = Mathf.Lerp(70f, 150f, distRatio);
      Vi /= KmPerH2MPerS;
    }
      else
      {
      Vi = GetInitialVelocity( );
      }
  ^{//} make adjustments to destination distance to accommodate drag
    dist += (dist * 0.15f) + (Vi / KmPerH2MPerS * 0.015f);
```

A more complete example is provided below, where this example code can be used for projectiles having a velocity between about 70 km/h to about 160 km/h with a multiplier based on the release velocity and a pitching target (with drag applied).

```
public void Launch( )
{
  Delivery delivery = currentDelivery;
  ballCollisions.hasHitBatOrPitch = false;
  ballTransform.position = ballLaunchPosition;
  afterShotBounce = false; // should be done on either reset or based on sound or on
intercepted
  nearBoundary = false;
  ballRenderer.enabled = true;
  ballBody.isKinematic = false;
  trailRenderer.enabled = false;
  // source and target positions
  Vector3 pos = transform.position;
  Vector3 target = delivery.targetPosition;
  throwSpeed = delivery.ballSpeed;
  ballState = BallState.Bowl;
  // distance between target and source
  float dist = Vector3.Distance(pos, target);
  // rotate the object to face the target
  transform.LookAt(target);
  float Vi = throwSpeed / KmPerH2MPerS;
  float angle = BallProjectile.Angle(dist, Vi);
  float Vy, Vz; // y,z components of the initial velocity
  Vy = Vi * Mathf.Sin(Mathf.Deg2Rad * angle);
  Vz = Vi * Mathf.Cos(Mathf.Deg2Rad * angle);
  // create the velocity vector in local space
  Vector3 localVelocity = new Vector3(0f, Vy, Vz);
  // transform it to global vector
  Vector3 globalVelocity = transform.TransformDirection(localVelocity);
  launch the projectile by setting its initial velocity
  ballBody.velocity = globalVelocity;
  trailRenderer.enabled = bowlingTrailEnabled;
  // Get the real landing target/bounce position with quadratic drag applied per //
physics frame. GetPitchingPoint function is shared at the end of this code
  Vector3 actualTarget = BallProjectile.GetPitchingPoint(ballBody);
  //Adjust the multiplier(3.5f) based on the releaseSpeed
  float mult = multiplier * (delivery.ballSpeed / 160f);
  //Calculate a target further ahead from the original target by multiplying the
difference in X and Z directions with the multiplier calculated earlier
  Vector3 newTarget = target + new Vector3(Mathf.Abs(target.x − actualTarget.x) *
mult, Of Mathf.Abs(target.z − actualTarget.z) * mult);
  // distance between target and source
  dist = Vector3.Distance(pos, newTarget);
  // rotate the object to face the target
  transform.LookAt(target);
  Vi = throwSpeed / KmPerH2MPerS;
  angle = BallProjectile.Angle(dist, Vi);
  Vy = Vi * Mathf.Sin(Mathf.Deg2Rad * angle);
  Vz = Vi * Mathf.Cos(Mathf.Deg2Rad * angle);
  // create the velocity vector in local space
  localVelocity = new Vector3(0f, Vy, Vz);
  // transform it to global vector
  globalVelocity = transform.TransformDirection(localVelocity);
  // launch the projectile by setting its initial velocity
  ballBody.velocity = globalVelocity;
  }
  // GetPitchingPoint function to get the actual bounce position with quadratic drag
  public static Vector3 GetPitchingPoint(Rigidbody ballBody)
  {
    List<Vector4> trajectoryInformation = new List<Vector4>( );
    Vector3 currentVelocity = ballBody.velocity;
    Vector3 p1 = ballBody.position;
    Vector4 finalVector = new Vector4(p1.x, p1.y, p1.z, 0f);
    bool bounced = false;
// loop only runs till the ball has bounced (usually up to a few hundred times)
    for (int i = 0; i < 2000; i++)
    {
    dragForce = −0.002f * currentVelocity.normalized *
currentVelocity.sqrMagnitude;
    //apply gravity to the projectile per time step
    currentVelocity += Physics.gravity * 0.002f;
    //apply drag.force to the projectile per time step
    currentVelocity += ((dragForce / ballBody.mass) * 0.002f);
    // calculate new position p2 in the next physics frame
    Vector3 p2 = p1 + currentVelocity * 0.002f;
    if (p2.y < (0.04f) && !bounced)
    {
      // the simulated projectile has bounced at position p2
      bounced = true;
      // we return the actual pitching point
      return p2;
    }
    p1 = p2;
    }
    //If trajectory never reaches the ground, return (−1f,−1f,−1f)
    return (Vector3.one * −1f);
  }
```

The computer code included above may be used as a technique to account for drag experienced by the ball along its trajectory. Because drag will be applied to a virtual representation of the ball, the distance the ball travels would otherwise decrease. So, in this example, a 15% factor is added to the distance that the ball travels to account for this decrease in distance that would otherwise be caused by the application of drag.

This approach accounts for the effects of drag on bowled balls, where faster balls experience less of an effect caused by drag than slower balls. The above-identified computer code is designed to work with fast and slow bowled balls, e.g., having about a 95% or higher accuracy. That is, the formula dist+=(dist*0.15f)+(Vi/KmPerH2MPerS*0.015f) may be used to account for drag of all bowled balls.

```
  //calculate firing angle needed for the ball to reach destination with initial
velocity
    float angle = BallProjectile.Angle(dist, Vi); //angle (formula) =
    ½(arcsinfg*dist/Vi\hat{ }2))
    float Vy, Vz; // y,z components of the initial velocity)
  //calculate horizontal and vertical components of velocity
    Vy = Vi * Mathf.Sin(Mathf.Deg2Rad * angle);
    Vz = Vi * Mathf.Cos(Mathf.Deg2Rad * angle);
  // create the velocity vector in local space
    Vector3 localVelocity = new Vector3(0f, Vy, Vz);
  // transform it to global vector
    Vector3 globalVelocity = transform.TransformDirection(localVelocity);
  // Calculating (BallProjectile.Angle(dist, Vi)) angle from..
    public static float Angle (float distance, float velocity)
    {
Formula to calculate angle given a target distance and launch velocity
    float angle = (Mathf.Asin((Physics.gravity.magnitude * distance) /
    (velocity) * velocity)) / 2f) * Mathf.Rad2Deg;
      if (angle.Equals(0f))
      { angle = 0.01f;
      }
      return angle;
    }
```

The computer code included above may use known physics to obtain the firing angle (i.e., launch angle) from the initial velocity and the starting/ending positions for the cricket ball. Specific vectors—i.e., the horizontal (y) and vertical (z) components—may be obtained through the above-identified code example as well. The lateral component (x) may remain zero in order to simplify calculations of a flight path, or a lateral component may be used, e.g., to model effects of spin, wind, or other factors that might laterally alter the flight path (such as a swing bowler in a cricket match adding swing to a bowled ball).

The foregoing provides sufficient physical information to recreate a trajectory in a virtual reality environment. This may include bounce location, post-bounce location, and post-bounce trajectory, etc. This path may then be translated into a global coordinate system viewed by a game player.
//launch the ball by setting its initial velocity ballBody.velocity=global Velocity; ballSpin.SeamBackSpin(throwSpeed /50f);

The computer code included above may launch the ball and add spin to the ball, which may be used for visualization purposes within the virtual reality environment, adjustments to lateral ball movement, or some combination of these.

After the exemplary computer code, swing (lateral movement of the ball) may be added. This may include adding a predetermined angular velocity based on a type of ball that is bowled—e.g., a fast ball or a spin ball—where the type of the ball may be included in projectile data as described herein. It will be understood that, if the release position is altered, even more swing may be added to the trajectory of a ball. Thus, in certain implementations, the release position from the live-action sequence may be altered within the virtual reality environment, e.g., to add additional swing to the trajectory of the ball.

A constant force may be applied to the ball at every frame (e.g., the drag discussed herein, or a sway or sideways force to simulate the effects of spin, etc.). By way of example, this may result in application of forces at each simulation step or each calculation, e.g., about 500 times per second. Other forces may also or instead be applied to the ball such as forces from weather (e.g., wind, rain, and so on), gravitational forces, and the like, which may use a physics engine or other library or the like, or may apply custom physics rules or algorithms, or some combination of these.

Post-Contact Rendering within a Virtual Reality Environment

Post-contact rendering within a virtual reality environment will now be described. For example, this may include the rendering of a ball (e.g., after contact with a bat or another object), a bat (e.g., after contact with a ball or another object), a player (e.g., a defensive player reacting to contact between a ball and a bat), and the like. It will be understood, however, that one or more of the techniques as described herein may be applied to post-contact rendering of any two objects within a virtual reality environment.

Specifically, using techniques described herein, the direction and terminal position of a projectile after contact with an object may be known, and this information may be used to further enhance realism in recreating a live-action sequence within a virtual reality environment. For example, the velocity and the position/orientation of the bat may be known at a variety of locations on the bat during a swing, and the position of the bat itself may be known at several moments in time throughout a swing—e.g., using sensors and/or cameras (or the like) as described herein, such as those discussed above for the various accessories for a virtual reality simulation system. This information may be used to calculate an exit velocity and directional vector for a ball after contact with the bat.

Below is example code for accurately predicting the path of a projectile (e.g., a cricket ball) after contact with an accessory (e.g., a cricket bat) for a virtual reality simulation of a live-action sequence (e.g., a cricket simulation), which can be used to trigger appropriate corresponding fielding animations and to create a realistic fielding model along with real-time commentary.

```
  // Returns the simulated path of the projectile post bat-hit
  public static List<Vector4> Trajectory(Rigidbody ballBody, int entries)
    {
  // A data structure to store the trajectory points
      List<Vector4> trajectoryInformation = new List<Vector4>( );
      Vector3 currentVelocity = ballBody.velocity;
      Vector3 p1 = ballBody.position;
      Vector4 finalVector = new Vector4(p1.x, p1.y, p1.z, 0f);
      bool bounced = false;
  // Run simulation loop to calculate predicted traj path
      for (int i = 0; i < entries; i++)
      {
        dragForce = −0.002f * currentVelocity.normalized *
  currentVelocity.sqrMagnitude;
        //Apply gravity on projectile per time step
        currentVelocity += Physics.gravity * 0.002f;
        //Apply drag on projectile per time step
        currentVelocity += ((dragForce / ballBody.mass) * 0.002f);
        // calculate p2 point in next time step
        Vector3 p2 = p1 + (currentVelocity * 0.002f);
        // if the y coordinate of p2 is less than the diameter of the ball it means the
  // ball has bounced
        if (p2.y < (0.04f) && !bounced)
        {
          // calculate subsequent bounce height
          float predictedVelocityY = currentVelocity.y * (0.28f) * −1f;
          // calculate friction components
          float predictedVelocityX = currentVelocity.x − currentVelocity.x *
  0.08f;
          float predictedVelocityZ = currentVelocity.z − currentVelocity.z * 0.08f;
          currentVelocity.y = predictedVelocityY;
          currentVelocity.x = predictedVelocityX;
          currentVelocity.z = predictedVelocityZ;
          bounced = true;
        }
        if (currentVelocity.y <= 0.0f && p2.y < 0.04f)
        {
          p2.y = 0.04f;
        }
        if (p2.y > 0.04f)
        {
          bounced = false;
        }
        p1 = p2;
        // calculate simulated position of the projectile for next time step
  finalVector = new Vector4(p1.x, p1.y, p1.z, i * 0.002f);
        // add simulated next position to the list of trajectory positions
        trajectoryInformation.Add(finalVector);
        if (currentVelocity.magnitude < 0.01f)
        {
          return trajectoryInformation;
        }
      }
      return trajectoryInformation;
}
```

Further, the location and trajectory of a ball after contact with the bat may account for external forces experienced by the cricket ball, such as drag, friction, bouncing, and so on. This information may be used to render virtual representations of one or more players interacting with, or attempting to interact with, the cricket ball along its trajectory. For example, fielding players, e.g., artificial intelligence defensive players, may be shown as moving toward (e.g., diving for) the cricket ball after contact with the bat, or otherwise reacting to a post-contact trajectory of the ball. By immediately pre-calculating the trajectory of a ball after contact with a bat, e.g., before or during rendering of an initial few frames of movement, player reactions may be determined in advance and animation sequences may be prepared to reflect player movements and avoid any accompanying latency that might otherwise occur when calculating player movement during the trajectory of the ball. According to the foregoing, in one aspect, there is disclosed herein a method for real time animation of a virtual reality gaming environment for cricket or other contact-based sports in which a ball trajectory is pre-calculated, and responsive player movements are also pre-calculated, in order to permit rendering of the ball and defensive players without observable latency. Responsive player movements may be determined using, e.g., a player-specific or position-specific artificial engine, or using any suitable rules or other techniques to estimate real world player responses to struck balls.

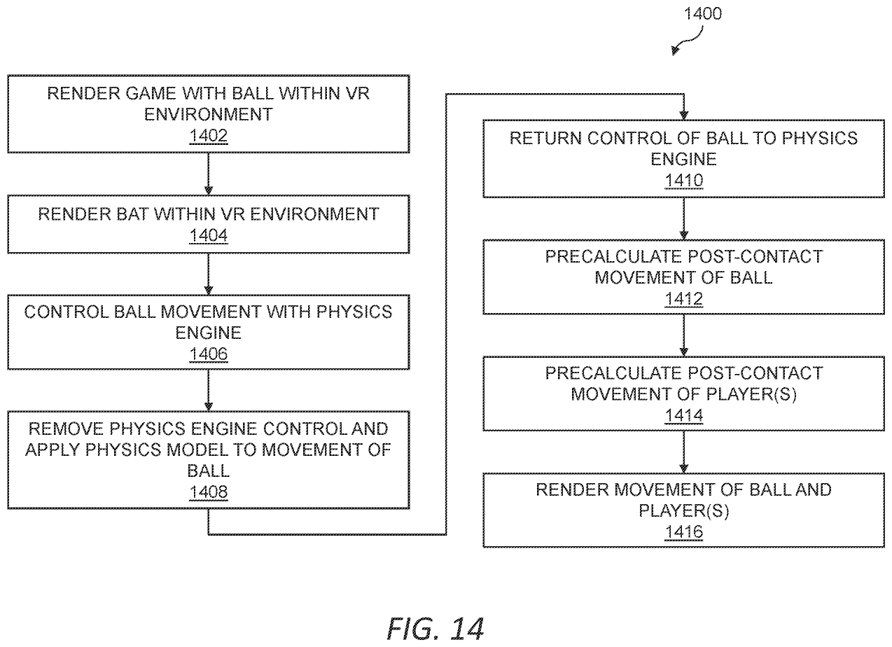

FIG. 14 is a flow chart of an exemplary method of virtual reality simulation. The method 1400 may be used to render accurate virtual representations of objects after a contact scenario, such as contact between a bat and a ball. More specifically, the method 1400 may employ one or more of the pre-calculations discussed above, e.g., to minimize latency when rendering post-contact movement and/or reactions related thereto.

As shown in step 1402, the method 1400 may include rendering a game including a ball within a virtual reality environment. The game and thus the virtual reality environment may include a physics engine that controls movement of the ball within the virtual reality environment. The physics engine may be the same or similar to those described above.

As shown in step 1404, the method 1400 may include rendering a bat within the virtual reality environment. The bat may be a virtual representation of an accessory (which, in this method 1400 may be referred to as a game controller) wielded by a player of the virtual reality game, where such an accessory may be the same or similar to any of those as described herein. Thus, the game controller may include one or more tracking devices operable to track a position of the game controller as described herein, and/or be in communication with one or more sensors that monitor a position of the game controller. In this manner, a location of the bat within the virtual reality environment can be controlled by the game controller.

As shown in step 1406, the method 1400 may include controlling movement of the ball within the virtual reality environment with the physics engine. In this manner, the physics engine may be used to, at least in part, control collisions between the ball and the bat within the virtual reality environment. The physics engine may be the same or similar to any of those described herein.

As shown in step 1408, the method 1400 may include removing control of the ball from the physics engine and applying a custom physics model to movement of the ball as the ball approaches a region of the bat (e.g., a region or estimated region where contact may occur). Thus, in one aspect, a customized physics model may be employed. For example, physics engines are known in the art, and may usefully be employed to simplify physics-related calculations, and to provide optimized algorithms and various forms of software acceleration or hardware acceleration for classic mechanics (e.g., Newtonian physics). However, this can prevent certain types of customization that use calculations and/or simulations outside the existing library of the physics engine. As a more specific example, many physics engines simplify aerodynamic drag as a linear phenomenon, although true aerodynamic drag is generally quadratic, and of the form:

$$Fd = \frac{1}{2} ρ {v}^{2} {C}_{D} A$$

where Fd is the drag force, ρ is the density of air, v is the speed of the ball through the air, A is the cross sectional area of the ball, and C_{D} is a dimensionless drag coefficient. When providing high-frame rate and/or high-quality virtual reality rendering of projectiles such as baseballs or cricket balls, the use of quadratic drag can produce a visibly more realistic user experience. To facilitate the use of this improved drag formula, a ball traveling toward a batsman or batter within the virtual reality environment may be taken out of the physics engine, processed using a quadratic drag formula and any other suitable physics refinements, and then reinserted into the virtual reality environment for the next rendered frame. In this latter context, it will be understood that the ball object (e.g., the computerized object within the virtual reality environment, including a current position and any other information specific to the ball) may be communicated to the physics engine, and/or the ball object may be communicated directly to a video rendering engine or other software as necessary or appropriate for the software/hardware architecture of the virtual reality environment. Where the physics engine specifically manages collisions with, e.g., a bat, control of the ball may be passed to the physics engine when the ball gets within a predetermined distance of the bat or bat region so that the collisions can be controlled by the physics engine. The predetermined distance may, for example, be a temporal distance such as 0.5 seconds, or a physical distance such as 2 meters.

Thus, as shown in step 1410, the method 1400 may include, when the ball approaches within a predetermined distance of the region of the bat, returning control of the ball to the physics engine and managing contact between the ball and the bat using the physics engine.

As shown in step 1412, the method 1400 may include pre-calculating a path of the ball after contact with the bat. For example, the full trajectory of the ball after a collision with a bat may be pre-calculated immediately upon contact. This permits other aspects of the virtual reality environment—e.g., the response to motion of the ball by artificial intelligence defensive players—to be determined and pre-rendered in order to reduce or eliminate rendering latency in the moments after contact.

As shown in step 1414, the method 1400 may include pre-calculating a response of one or more artificial intelligence defensive players to the path of the ball after contact with the bat. And, as shown in step 1416, the method 1400 may include rendering one or more of these artificial intelligence defensive players at a frame rate of the virtual reality environment, which may result in no visible latency. The response may be a reaction—e.g., similar to a reaction that a real-world player would have—to a contact scenario, such as one or more of those described herein. For example, this may include one or more players moving in a direction toward the ball, moving away from the ball, moving toward a trajectory of the ball, diving, jumping, sliding, celebrating, reacting in a deflated manner (e.g., hanging head or looking down, and the like), running, walking, and so on.

Thus, the method 1400 may include pre-calculating a path of the ball after contact with the bat, pre-calculating a response of one or more artificial intelligence defensive players to the path of the ball after contact, and rendering the one or more artificial intelligence defensive players at a frame rate of the virtual reality environment with no observable latency. As described herein, the ball may be a baseball, a cricket ball, a squash ball, a tennis ball, or any other game ball. The bat may be a baseball bat or a cricket bat, however it will be understood that other sports equipment may be used, such as a squash racquet, a tennis racquet, and so forth. In another aspect, the custom physics model may include a quadratic drag equation for movement of the ball within the virtual reality environment. The physics engine may use one or more platform-optimized physics calculations, and may include hardware acceleration, graphics processing unit optimizations, physics processing unit optimizations, multicore CPU processing optimizations, video card optimizations, multithreading, and so forth.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method for virtual reality simulation of a projectile, the method comprising:
obtaining projectile data characterizing a trajectory of a projectile launched by a player in a live-action sequence, the projectile data including: (i) a first position of the projectile corresponding to a location where the projectile is launched by the player, (ii) an initial velocity of the projectile when the projectile is launched by the player, (iii) a bounce position where the projectile contacts a playing surface or is projected to contact the playing surface after being launched by the player, and (iv) a known downstream position of the projectile at a predetermined location downstream from the bounce position;
calculating a launch angle for the projectile at, or immediately downstream of, the first position based on the projectile data;
calculating a post-bounce velocity and determining a post-bounce directional vector at a location immediately downstream from the bounce position using: (i) a predetermined coefficient of restitution between the playing surface and the projectile, and (ii) the known downstream position;
determining a post-bounce trajectory disposed between the bounce position and the known downstream position using the post-bounce velocity, the post-bounce directional vector, and the known downstream position; and
rendering a graphical representation of the trajectory, including the post-bounce trajectory, with a virtual projectile in a display of a virtual reality environment.

2. The method of claim 1, wherein the virtual reality environment is configured for use in a virtual reality cricket simulation, wherein the projectile is a cricket ball and the player in the live-action sequence is a bowler in a cricket match.

3. The method of claim 1, wherein the post-bounce velocity is calculated using a predetermined decrease in velocity from a pre-bounce velocity, the pre-bounce velocity derived from the initial velocity.

4. The method of claim 3, wherein the predetermined decrease in velocity is between 10% and 15%.

5. The method of claim 3, wherein the predetermined decrease in velocity is based at least in part on an attribute of the playing surface that is identified in the projectile data.

6. The method of claim 5, wherein the attribute of the playing surface includes at least one of a composition of the playing surface, a geographic location of the playing surface, a wetness of the playing surface, and an environmental condition.

7. The method of claim 3, wherein the predetermined decrease in velocity is based at least in part on an attribute of the player that launched the projectile that is identified in the projectile data.

8. The method of claim 3, wherein the predetermined decrease in velocity is based at least in part on the pre-bounce velocity.

9. The method of claim 8, wherein, when the pre-bounce velocity is above a predetermined threshold, a first decrease in velocity is used for the post-bounce velocity, and when the pre-bounce velocity is below the predetermined threshold, a second decrease in velocity is used for the post-bounce velocity, the second decrease in velocity being greater than the first decrease in velocity.

10. The method of claim 1, wherein rendering the graphical representation of the trajectory, including the post-bounce trajectory, with the virtual projectile includes a displacement of the virtual projectile along the playing surface from the bounce position.

11. A method for virtual reality simulation of a projectile, the method comprising:
obtaining projectile data characterizing a trajectory of a projectile launched by a player in a live-action sequence, the projectile data including: (i) a first position of the projectile corresponding to a location where the projectile is launched by the player, (ii) an initial velocity of the projectile when the projectile is launched by the player, and (iii) a second position of the projectile along the trajectory at a second position time, the second position disposed downstream from the first position along the trajectory;
calculating a launch angle for the projectile at, or immediately downstream of, the first position based on the projectile data;
calculating a number of locations of the projectile along the trajectory based on the projectile data, the launch angle, a mass of the projectile, and application of a predetermined drag coefficient to the projectile, wherein the number of locations form a first virtual trajectory; and
rendering a graphical representation of the first virtual trajectory with a virtual projectile in a display of a virtual reality environment.

12. The method of claim 11, wherein the virtual reality environment is configured for use in a virtual reality cricket simulation, wherein the projectile is a cricket ball and the player in the live-action sequence is a bowler in a cricket match.

13. The method of claim 11, wherein the second position is a bounce position of the projectile first contacting a playing surface after being launched by the player.

14. The method of claim 13, wherein the first virtual trajectory is disposed between the first position and the bounce position.

15. The method of claim 11, further comprising calculating a directional vector of the projectile at the number of locations.

16. The method of claim 11, wherein the predetermined drag coefficient corresponds to quadratic drag applied to the projectile.

17. The method of claim 11, wherein the predetermined drag is applied at every frame of the graphical representation of the first virtual trajectory.

18. The method of claim 11, further comprising verifying the first virtual trajectory based on the second position and the second position time.

19. The method of claim 18, further comprising adjusting the predetermined drag coefficient according to a deviation between the first virtual trajectory and the second position at the second position time thereby creating a second virtual trajectory.

20. The method of claim 11, further comprising comparing a reaction time within the graphical representation to an actual reaction time in the live-action sequence, and adjusting the first virtual trajectory based on a difference therebetween.
